(19) United States
(12) Patent Application Publication
(10) Pub. No.: US 2024/0236870 A9
(43) Pub. Date: Jul. 11, 2024

(54) REFERENCE SIGNAL AVAILABLE SLOT INDICATION BY GROUP COMMON DOWNLINK CONTROL INFORMATION

(71) Applicant: QUALCOMM INCORPORATED, San Diego, CA (US)

(72) Inventors: Runxin WANG, San Diego, CA (US); Muhammad Sayed Khairy ABDELGHAFFAR, San Jose, CA (US); Yu ZHANG, San Diego, CA (US)

(21) Appl. No.: 18/548,312

(22) PCT Filed: Apr. 16, 2021
(86) PCT No.: PCT/CN2021/087699

§ 371 Date: Aug. 29, 2023

(51) Int. Cl. H04W 52/32; H04L 5/00

(52) U.S. Cl. CPC H04W 52/325; H04L 5/0051

(57) ABSTRACT

Methods, systems, and devices for wireless communications are described. The method includes receiving, from a base station, control information identifying a configuration for transmission of an aperiodic sounding reference signal, receiving, from the base station, a downlink control message including a set of one or more blocks, where each block of the one or more blocks includes a sounding reference signal request in accordance with the configuration for transmission of an aperiodic sounding reference signal, an indication of an available slot corresponding to that block, and one or more transmit power control commands, and transmitting, during the available slot corresponding to a block of the set of one or more blocks, the aperiodic sounding reference signal in accordance with a power level indicated by the one or more transmit power control commands corresponding to the block.

### CROSS REFERENCE

The present Application is a 371 national stage filing of International PCT Application No. PCT/CN2021/087699 by WANG et al. entitled “REFERENCE SIGNAL AVAILABLE SLOT INDICATION BY GROUP COMMON DOWNLINK CONTROL INFORMATION,” filed Apr. 16, 2021, which is assigned to the assignee hereof, and which is expressly incorporated by reference in its entirety herein.

### FIELD OF TECHNOLOGY

The following relates to wireless communications, including reference signal available slot indication by group common downlink control information.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless systems, sounding reference signals transmitted by a UE are measured by a base station and used to optimize a downlink connection between the base station and the UE.

### SUMMARY

The described techniques relate to improved methods, systems, devices, and apparatuses that support using downlink control information to indicate an available reference signal slot, such as a slot for transmitting a sounding reference signal. Generally, the described techniques provide for a user equipment (UE) receiving, from a base station, control information and a downlink control message. The control information indicates a configuration for the UE to use when transmitting an aperiodic sounding reference signal to the base station. The downlink control message includes a set of blocks, each block including a sounding reference signal request (e.g., a 2-bit codepoint) associated with the configuration the UE uses to transmit the aperiodic sounding reference signal. A given block also includes one or more transmit power control commands and an indication of an available slot corresponding to that block (e.g., a first available slot indication corresponding to a first block, a second available slot indication corresponding to a second block, etc.). For a given block, the UE transmits, during the available slot corresponding to the given block, the aperiodic sounding reference signal in accordance with a power level indicated by the one or more transmit power control commands corresponding to the given block.

A method for wireless communication at a user equipment (UE) is described. The method may include receiving, from a base station, control information identifying a configuration for transmission of an aperiodic sounding reference signal, receiving, from the base station, a downlink control message including a set of one or more blocks, where each block of the one or more blocks includes a sounding reference signal request in accordance with the configuration for transmission of an aperiodic sounding reference signal, an indication of an available slot corresponding to that block, and one or more transmit power control commands, and transmitting, during the available slot corresponding to a block of the set of one or more blocks, the aperiodic sounding reference signal in accordance with a power level indicated by the one or more transmit power control commands corresponding to the block.

An apparatus for wireless communication at a UE is described. The apparatus may include a processor, memory coupled with the processor, and instructions stored in the memory. The instructions may be executable by the processor to cause the apparatus to receive, from a base station, control information identifying a configuration for transmission of an aperiodic sounding reference signal, receive, from the base station, a downlink control message including a set of one or more blocks, where each block of the one or more blocks includes a sounding reference signal request in accordance with the configuration for transmission of an aperiodic sounding reference signal, an indication of an available slot corresponding to that block, and one or more transmit power control commands, and transmit, during the available slot corresponding to a block of the set of one or more blocks, the aperiodic sounding reference signal in accordance with a power level indicated by the one or more transmit power control commands corresponding to the block.

Another apparatus for wireless communication at a UE is described. The apparatus may include means for receiving, from a base station, control information identifying a configuration for transmission of an aperiodic sounding reference signal, means for receiving, from the base station, a downlink control message including a set of one or more blocks, where each block of the one or more blocks includes a sounding reference signal request in accordance with the configuration for transmission of an aperiodic sounding reference signal, an indication of an available slot corresponding to that block, and one or more transmit power control commands, and means for transmitting, during the available slot corresponding to a block of the set of one or more blocks, the aperiodic sounding reference signal in accordance with a power level indicated by the one or more transmit power control commands corresponding to the block.

A non-transitory computer-readable medium storing code for wireless communication at a UE is described. The code may include instructions executable by a processor to receive, from a base station, control information identifying a configuration for transmission of an aperiodic sounding reference signal, receive, from the base station, a downlink control message including a set of one or more blocks, where each block of the one or more blocks includes a sounding reference signal request in accordance with the configuration for transmission of an aperiodic sounding reference signal, an indication of an available slot corresponding to that block, and one or more transmit power control commands, and transmit, during the available slot corresponding to a block of the set of one or more blocks, the aperiodic sounding reference signal in accordance with a power level indicated by the one or more transmit power control commands corresponding to the block.

Some examples of the method, apparatuses, and non-transitory computer-readable medium described herein may further include operations, features, means, or instructions for identifying, based on the configuration, a set of uplink component carriers that correspond to the block.

In some examples of the method, apparatuses, and non-transitory computer-readable medium described herein, transmitting the aperiodic sounding reference signal during the identified slot may include operations, features, means, or instructions for transmitting the aperiodic sounding reference signal on each component carrier of the set of uplink component carriers corresponding to the block.

Some examples of the method, apparatuses, and non-transitory computer-readable medium described herein may further include operations, features, means, or instructions for identifying, based on the configuration, a first component carrier of the set of uplink component carriers that corresponds to a first transmit power control command of the one or more transmit power control commands and a second component carrier of the set of uplink component carriers that corresponds to a second transmit power control command of the one or more transmit power control commands.

In some examples of the method, apparatuses, and non-transitory computer-readable medium described herein, transmitting the aperiodic sounding reference signal during the identified slot may include operations, features, means, or instructions for transmitting the aperiodic sounding reference signal on the first component carrier at a first power level indicated by the first transmit power control command, and transmitting the aperiodic sounding reference signal on the second component carrier at a second power level indicated by the second transmit power control command, where the second power level may be different than or equal to the first power level.

Some examples of the method, apparatuses, and non-transitory computer-readable medium described herein may further include operations, features, means, or instructions for identifying, based on the configuration, a component carrier that corresponds to the block, where the component carrier corresponds to a transmit power control command of the one or more transmit power control commands and transmitting the aperiodic sounding reference signal on the component carrier at a power level indicated by the transmit power control command.

Some examples of the method, apparatuses, and non-transitory computer-readable medium described herein may further include operations, features, means, or instructions for identifying, based on the configuration, a mapping between the sounding reference signal request and the indication of an available slot, and that a set of sounding reference signal resources corresponds to the sounding reference signal request.

Some examples of the method, apparatuses, and non-transitory computer-readable medium described herein may further include operations, features, means, or instructions for identifying, based on the configuration, a component carrier that corresponds to the set of sounding reference signal resources, where the component carrier corresponds to a transmit power control command of the one or more transmit power control commands and using the set of sounding reference signal resources to transmit the aperiodic sounding reference signal on the component carrier at a power level indicated by the transmit power control command.

Some examples of the method, apparatuses, and non-transitory computer-readable medium described herein may further include operations, features, means, or instructions for identifying, based on the configuration, a set of multiple component carriers that correspond to the set of sounding reference signal resources, where the set of multiple component carriers corresponds to a transmit power control command of the one or more transmit power control commands, where each of the set of multiple component carriers point to the block and using the set of sounding reference signal resources to transmit, during the identified slot, the aperiodic sounding reference signal on each of the set of multiple component carriers at a power level indicated by the transmit power control command.

Some examples of the method, apparatuses, and non-transitory computer-readable medium described herein may further include operations, features, means, or instructions for identifying the indication of the available slot based on the configuration, where the configuration maps the indication of the available slot to the block.

Some examples of the method, apparatuses, and non-transitory computer-readable medium described herein may further include operations, features, means, or instructions for identifying a second indication of one or more available slots in an available slots field of a second block.

In some examples of the method, apparatuses, and non-transitory computer-readable medium described herein, the configuration or the downlink control message, or both, include a first pointer associated with a third block that points to a third indication of one or more available slots, and the configuration or the downlink control message, or both, include a second pointer associated with the third block that points to a sounding reference signal request and one or more transmit power control commands of the third block.

Some examples of the method, apparatuses, and non-transitory computer-readable medium described herein may further include operations, features, means, or instructions for identifying a first component carrier of a set of uplink component carriers associated with the block that corresponds to the indication of the available slot and a second component carrier of the set of uplink component carriers that corresponds to a second indication of one or more available slots, where the available slots field of the block includes the second indication of the one or more available slots.

In some examples of the method, apparatuses, and non-transitory computer-readable medium described herein, the indication of the available slot includes a slot offset value, and identifying the slot includes identifying the slot based on the slot offset value.

In some examples of the method, apparatuses, and non-transitory computer-readable medium described herein, identifying the slot may include operations, features, means, or instructions for identifying the slot based on a reference slot indicated by the configuration or the downlink control message, or indicated by both, where the reference slot may be measured from the downlink control message, or from a combination of the downlink control message and a slot offset value, or a first slot available after the UE performs a component carrier switching procedure, or any combination thereof.

Some examples of the method, apparatuses, and non-transitory computer-readable medium described herein may further include operations, features, means, or instructions for receiving a list of index values in the configuration, or in a message from the base station, where the configuration includes an index value that maps to an entry of the list of index values, where the entry of the list of index values indicates the available slot that corresponds to the block.

A method for wireless communication at a base station is described. The method may include transmitting, to a UE, control information identifying a configuration for transmission of an aperiodic sounding reference signal, transmitting, to the UE, a downlink control message including a set of one or more blocks, where each block of the one or more blocks includes a sounding reference signal request in accordance with the configuration for transmission of an aperiodic sounding reference signal, an indication of an available slot corresponding to that block, and one or more transmit power control commands, and receiving, from the UE during the available slot corresponding to a block of the set of one or more blocks, the aperiodic sounding reference signal in accordance with a power level indicated by the one or more transmit power control commands corresponding to the block.

An apparatus for wireless communication at a base station is described. The apparatus may include a processor, memory coupled with the processor, and instructions stored in the memory. The instructions may be executable by the processor to cause the apparatus to transmit, to a UE, control information identifying a configuration for transmission of an aperiodic sounding reference signal, transmit, to the UE, a downlink control message including a set of one or more blocks, where each block of the one or more blocks includes a sounding reference signal request in accordance with the configuration for transmission of an aperiodic sounding reference signal, an indication of an available slot corresponding to that block, and one or more transmit power control commands, and receive, from the UE during the available slot corresponding to a block of the set of one or more blocks, the aperiodic sounding reference signal in accordance with a power level indicated by the one or more transmit power control commands corresponding to the block.

Another apparatus for wireless communication at a base station is described. The apparatus may include means for transmitting, to a UE, control information identifying a configuration for transmission of an aperiodic sounding reference signal, means for transmitting, to the UE, a downlink control message including a set of one or more blocks, where each block of the one or more blocks includes a sounding reference signal request in accordance with the configuration for transmission of an aperiodic sounding reference signal, an indication of an available slot corresponding to that block, and one or more transmit power control commands, and means for receiving, from the UE during the available slot corresponding to a block of the set of one or more blocks, the aperiodic sounding reference signal in accordance with a power level indicated by the one or more transmit power control commands corresponding to the block.

A non-transitory computer-readable medium storing code for wireless communication at a base station is described. The code may include instructions executable by a processor to transmit, to a UE, control information identifying a configuration for transmission of an aperiodic sounding reference signal, transmit, to the UE, a downlink control message including a set of one or more blocks, where each block of the one or more blocks includes a sounding reference signal request in accordance with the configuration for transmission of an aperiodic sounding reference signal, an indication of an available slot corresponding to that block, and one or more transmit power control commands, and receive, from the UE during the available slot corresponding to a block of the set of one or more blocks, the aperiodic sounding reference signal in accordance with a power level indicated by the one or more transmit power control commands corresponding to the block.

### BRIEF DESCRIPTION OF THE DRAWINGS

FIG. 1 illustrates an example of a wireless communications system that supports using downlink control information to indicate an available reference signal slot in accordance with aspects of the present disclosure.

FIG. 2 illustrates an example of a wireless communications system that supports using downlink control information to indicate an available reference signal slot in accordance with aspects of the present disclosure.

FIG. 3 illustrates an example of a Type-A signaling scheme that supports using downlink control information to indicate an available reference signal slot in accordance with aspects of the present disclosure.

FIG. 4 illustrates an example of an alternative Type-A configuration table that supports using downlink control information to indicate an available reference signal slot in accordance with aspects of the present disclosure.

FIG. 5 illustrates an example of a Type-B signaling scheme that supports using downlink control information to indicate an available reference signal slot in accordance with aspects of the present disclosure.

FIG. 6 illustrates an example of an alternative Type-B configuration table that supports using downlink control information to indicate an available reference signal slot in accordance with aspects of the present disclosure.

FIG. 7 illustrates an example of a Type-A signaling scheme that supports using downlink control information to indicate an available reference signal slot in accordance with aspects of the present disclosure.

FIG. 8 illustrates an example of a Type-A signaling scheme that supports using downlink control information to indicate an available reference signal slot in accordance with aspects of the present disclosure.

FIG. 9 illustrates an example of a Type-B signaling scheme that supports using downlink control information to indicate an available reference signal slot in accordance with aspects of the present disclosure.

FIG. 10 illustrates an example of a scheduling that supports using downlink control information to indicate an available reference signal slot in accordance with aspects of the present disclosure.

FIGS. 11 and 12 show block diagrams of devices that support using downlink control information to indicate an available reference signal slot in accordance with aspects of the present disclosure.

FIG. 13 shows a block diagram of a communications manager that supports using downlink control information to indicate an available reference signal slot in accordance with aspects of the present disclosure.

FIG. 14 shows a diagram of a system including a device that supports reference signal available slot indication by group common downlink control information in accordance with aspects of the present disclosure.

FIGS. 15 and 16 show block diagrams of devices that support reference signal available slot indication by group common downlink control information in accordance with aspects of the present disclosure.

FIG. 17 shows a block diagram of a communications manager that supports reference signal available slot indication by group common downlink control information in accordance with aspects of the present disclosure.

FIG. 18 shows a diagram of a system including a device that supports reference signal available slot indication by group common downlink control information in accordance with aspects of the present disclosure.

FIGS. 19 through 21 show flowcharts illustrating methods that support reference signal available slot indication by group common downlink control information in accordance with aspects of the present disclosure.

### DETAILED DESCRIPTION

The present techniques include using downlink control information to indicate an available reference signal slot. The sounding reference signal (SRS) is a reference signal that a UE may transmit to a base station. The base station may use the SRS for resource scheduling (e.g., uplink timing estimation as part of timing alignment procedure, uplink frequency selective scheduling, etc.). An aperiodic SRS may be configured by radio resource control (RRC) signaling, then triggered by an SRS request in a PDCCH downlink control information (DCI), such as a group common DCI. The group common DCI may include multiple blocks.

According to a first type of SRS triggering (“Type-A”), a block of the DCI that triggers the SRS request may refer to a set of component carriers (CCs), and may include an SRS request (a 2-bit value) and a separate transmit power control (TPC) command (a 2-bit value) for each CC in the CC set. According to a second type of SRS triggering (“Type-B”), each block of the DCI may refer to an individual separate individual CC and include the SRS request and a TPC command for the single CC. Under previous and existing systems, a slot for transmitting the SRS to the base station may be specified based on a configured or standardized SRS offset from the triggering DCI, but the UE may not be able to transmit the SRS at the specified slot due to resources of that slot being unavailable for SRS transmissions (e.g. the resources are converted from a flexible (F) slot to a downlink (DL) slot, or a collision occurs with a higher priority signal/channel, or PDCCH congestion occurs for multi-user SRS triggering based on the base station sending multiple PDCCHs at the specified slot).

The present techniques provide slot availability for SRS transmissions by including an indication of an available SRS slots with the SRS request in the triggering DCI. The indication of available slots may be indicated implicitly or explicitly in the DCI. An implicit indication of available SRS slots may not rely on any new DCI field, and may instead rely on a mapping of a CC set of a DCI block (Type A) to a set of one or more available SRS slots, or on a mapping of a set of SRS resources of the DCI block (Type B) to a set of one or more available SRS slots. The mapping may be indicated or configured previously by RRC or media access control (MAC) control element (MAC-CE).

An explicit indication of available SRS slots may use a new DCI field to communicate the indication of available slots directly to the UE. The explicit solution may indicate a reference slot to enable the UE to identify the available slot (e.g., based on the reference slot and the indication of available slots).

Under both the implicit and explicit solutions, each CC of the CC set may be mapped to the same indication of available slots (Type A), or each SRS resource of the SRS resource set may be mapped to the same indication of available slots (Type B). Under the implicit and explicit solutions, each CC of the CC set may be mapped to different indications of available slots (Type A), or each SRS resource of the SRS resource set may be mapped to different indications of available slots (Type B).

Aspects of the subject matter described herein may be implemented to realize one or more advantages. The described techniques may support improvements in system efficiency such that latencies associated with devices transmitting SRSs is reduced. Additionally, described techniques may result in avoiding transmission delays, multiple retransmissions and failed transmissions, decreasing system latency, improving the reliability of SRS transmissions, and improving user experience.

Aspects of the disclosure are initially described in the context of wireless communications systems. Aspects of the disclosure are further illustrated by and described with reference to configurations and schedulings of downlink control messages that relate to using downlink control information to indicate an available reference signal slot. Aspects of the disclosure are further illustrated by and described with reference to apparatus diagrams, system diagrams, and flowcharts that relate to using downlink control information to indicate an available reference signal slot.

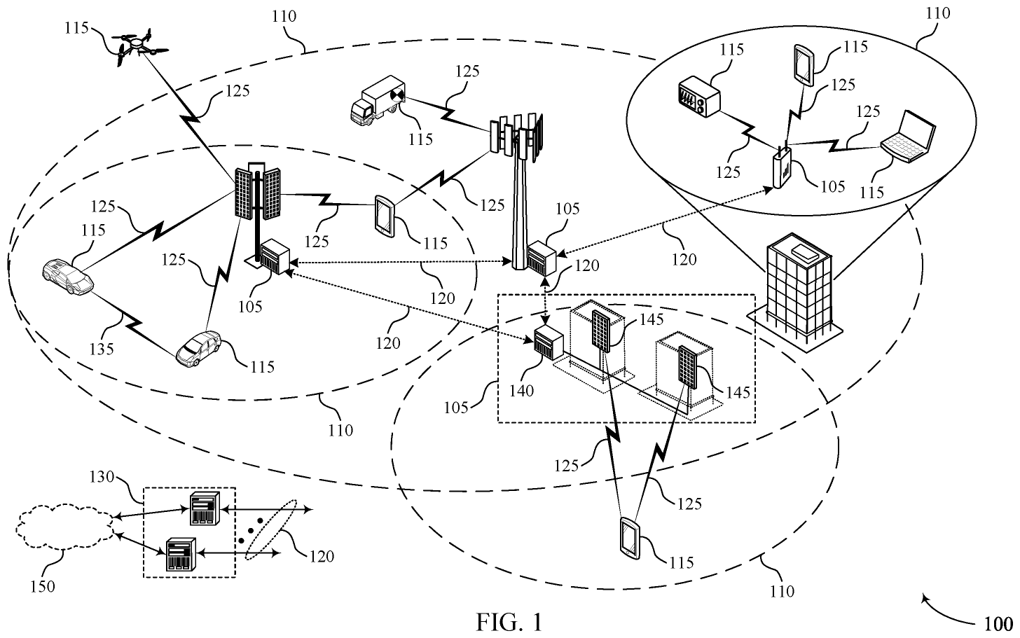

FIG. 1 illustrates an example of a wireless communications system 100 that supports reference signal available slot indication by group common downlink control information in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N f) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, a UE 115 of FIG. 1 may receive control information or a downlink control message, or both, from a base station 105. The received control information may indicate a configuration for UE 115 to use when transmitting an aperiodic sounding reference signal to base station 105. The downlink control message may include a set of blocks, where each block includes a sounding reference signal request (e.g., a 2-bit codepoint) associated with the configuration the UE 115 is to use to transmit the aperiodic sounding reference signal. A given block may include one or more transmit power control commands. In some cases, a given block may include an indication of an available slot (e.g., the 2-bit codepoint mapped to the indication of the available slot) corresponding to that block. For a given block, UE 115 may transmit, during the available slot corresponding to the given block, the aperiodic sounding reference signal in accordance with a power level indicated by the one or more transmit power control commands corresponding to the given block.

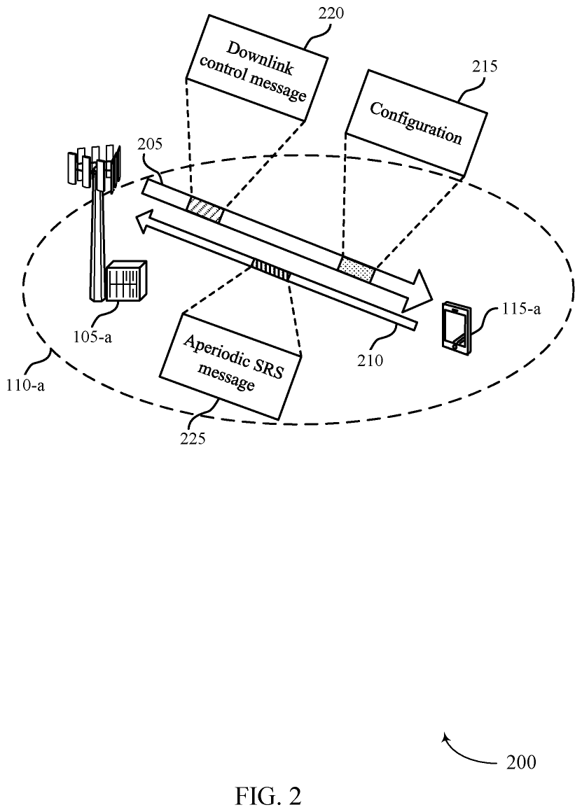

FIG. 2 illustrates an example of a wireless communications system 200 that supports using downlink control information to indicate an available reference signal slot in accordance with aspects of the present disclosure.

As illustrated, wireless communications system 200 may include UE 115-a and base station 105-a, which may be examples of a UE 115 or a base station 105, as described above with reference to FIG. 1. Wireless communications system 200 may also include downlink 205 and uplink 210. Base station 105-a may use downlink 205 to convey control and/or data information to UE 115-a. And UE 115-a may use uplink 210 to convey control and/or data information to base station 105-a. In some cases, downlink 205 may use different time and/or frequency resources than uplink 210. As depicted, base station 105-a may be associated with geographic coverage area 110-a in which communications with one or more UEs (e.g., UE 115-a) is supported.

In the illustrated example, UE 115-a may receive one or more transmissions from base station 105-a. In some cases, the one or more transmissions may include a configuration 215 (e.g., a message including configuration 215 or an indication of configuration 215 for UE 115-a to use to transmit an aperiodic sounding reference signal). In some cases, UE 115-a may receive the configuration 215 in a radio resource control message or a media access control (MAC) control element (MAC-CE) message, or both.

In some examples, the one or more transmissions may include downlink control message 220. In some cases, downlink control message 220 may include one or more blocks. Each block may include a sounding reference signal request associated with the configuration 215 the UE 115-a is to use to transmit the aperiodic sounding reference signal. In some cases, the sounding reference signal request of a given block may include a 2-bit value (e.g., a 2-bit codepoint).

In some examples, a block of downlink control message 220 may include one or more transmit power control commands. In some cases, a block of downlink control message 220 may include an indication of an available slot for transmitting the requested SRS. The indication of an available slot may be signaled as an offset measured from a reference slot that is known or signaled to the UE. In some cases, the indication of the available slot may be based on the configuration 215 (e.g., the configuration 215 providing a mapping between the 2-bit codepoint and the indication of the available slot).

In some examples, UE 115-a may transmit, during the available slot corresponding to a given block, the aperiodic sounding reference signal 225 in accordance with a power level indicated by the one or more transmit power control commands corresponding to the given block.

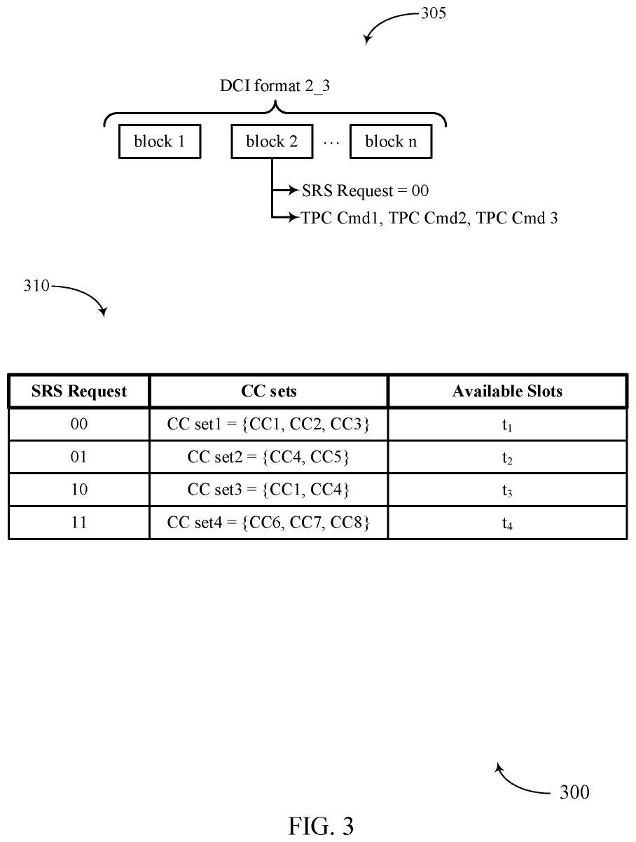

FIG. 3 illustrates an example of a Type-A signaling scheme 300 that supports using downlink control information to indicate an available reference signal slot in accordance with aspects of the present disclosure. In some examples, the signaling scheme 300 may include downlink control information (DCI) 305 (e.g., downlink control message 220 of FIG. 2) and configuration table 310. In some cases, DCI 305 may include a group common DCI (GC-DCI, type A GC-DCI). As shown, configuration table 310 depicts one or more aspects of the signaling scheme 300. In some cases, aspects associated with the signaling scheme 300 may be performed by a UE (e.g., UE 115 as described herein) or a base station (e.g., base station 105 as described herein), or both.

As shown, DCI 305 may include n blocks (e.g., block 1, block 2, up to block n), n being a positive integer. Each block may be associated with a sounding reference signal (SRS) request and multiple transmit power control (TPC) commands. As shown, block 2 may be associated with SRS request with a 2-bit codepoint value of 00 and TPC command 1, TPC command 2, and TPC command 3.

In some examples, an SRS request triggers an SRS transmission. In addition to triggering the SRS transmission, the SRS request may map to available slots. In some cases, DCI 305 may include one or more slot offsets (e.g., block 1 includes a first slot offset; block 2 includes a second slot offset). When slot offset=1, then the UE may transmit the SRS in a first available slot. However, with the available slot indicators, a UE may transmit in any slot the DCI indicates is available (e.g., a slot with uplink symbols).

In some examples, a base station may transmit an RRC or MAC control element (MAC-CE) configuration message to the UE prior to triggering the SRS transmission via DCI 305. In some cases, the configuration message may include or reference configuration table 310 or at least a portion of the information depicted in configuration table 310 (e.g., a portion of the information depicted in configuration table 310 formatted as shown or in a different format). In some cases, configuration table 310 may include possible values (e.g., 2-bit codepoint values) for SRS requests. As shown, configuration table 310 may map each SRS request to a set of component carriers (CCs). In the illustrated example, an SRS request 00 maps to CC set 1, an SRS request 01 maps to CC set 1, an SRS request 10 maps to CC set 2, and an SRS request 11 maps to CC set 3. As shown, CC set 1 includes component carriers CC1, CC2, and CC3; CC set 2 includes component carriers CC4 and CCS; CC set 3 includes component carriers CC1 and CC4; and CC set 4 includes component carriers CC6, CC7, and CCB.

In some examples, configuration table 310 provides an implicit way to indicate available slots indicators without adding any new field to DCI 305. In some cases, configuration table 310 maps each SRS request or each CC set, or both, to an available slots indicator (e.g., multiple CCs mapped to one available slots indicator). In the illustrated example, configuration table 310 maps available slot indicator t1 to SRS request 00 or CC set 1, or both; maps available slot indicator t2 to SRS request 01 or CC set 2, or both; maps available slot indicator t3 to SRS request 10 or CC set 3, or both; and maps available slot indicator t4 maps to SRS request 11 or CC set 4, or both. In some cases, each available slots indicator (e.g., t1, t2, t3, t4) may indicate one or more slots available for a UE to transmit an SRS. Accordingly, configuration table 310 maps available slot indicator t1 to CC1, CC2, and CC3 of CC set 1; maps available slot indicator t2 to CC4 and CC5 of CC set 2; maps available slot indicator t3 to CC1 and CC4 of CC set 3; and maps available slot indicator t4 to CC6, CC7, and CC8 of CC set 4.

In some examples, configuration table 310 may map CCs of a given CC set to the TPC commands of a given block. In the provided example, configuration table 310 may map TPC command 1 to CC1 of CC set 1; map TPC command 2 to CC2 of CC set 1; and map TPC command 3 to CC3 of CC set 1. Accordingly, in the illustrated example, block 2 may include SRS request 00, TPC command 1, TPC command 2, and TPC command 3, and configuration table 310 may map SRS request 00 to CC set 1 and available slot indicator t1.

In some cases, the base station may indicate information associated with configuration table 310 via a configuration message. The configuration message may be transmitted via a radio resource control (RRC) message or a media access control (MAC) control element (MAC-CE), or both.

In some cases, the configuration message may include actual values of available slot indicators (e.g., t1=16) or the configuration message may include indexed values of available slot indicators (e.g., t2=index 3), or both. In some cases, the UE may be preconfigured (e.g., configured before establishing a connection with the base station, etc.) with a list of one or more index values (e.g., index list including index 1=8; index 2=4; index 3=16; index 4=32; etc.). Accordingly, configuration table 310 may include one or more index values (e.g., t2=index 3) that map at least one component carrier to an available slots indicator according to the list of index values.

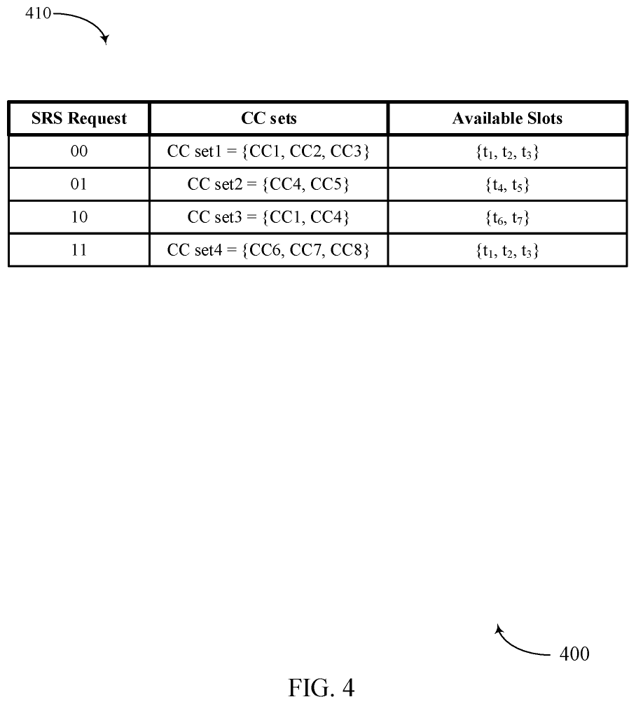

FIG. 4 illustrates an example of an alternative Type-A configuration table 410. Configuration table 410 may be an alternative example of configuration table 310 of FIG. 3, and may be signaled to the UE in an RRC or MAC-CE message prior to a DCI 305 triggering an SRS transmission by the UE.

In some examples, configuration table 410 provides an implicit way to indicate available slots indicators without adding any new field to a DCI (e.g., DCI 305). In some cases, configuration table 410 may map multiple available slot indicators to an SRS request, and individually map each of the multiple available slot indicators to a CC of a CC set (e.g., one-to-one mappings between one CC of a CC set and one available slot indicator of the multiple available slot indicators per block). In the illustrated example, configuration table 410 maps available slot indicators t1, t2, and t3 to SRS request 00; maps available slot indicators t4 and t5 to SRS request 01; maps available slot indicators t6 and t7 to SRS request 10; and maps available slot indicators t1, t2, and t3 to SRS request 11. Additionally, or alternatively, configuration table 410 maps available slot indicator t1 to CC1 of CC set 1; maps available slot indicator t2 to CC2 of CC set 1; maps available slot indicator t3 to CC3 of CC set 1; maps available slot indicator t4 to CC4 of CC set 2; maps available slot indicator t5 to CC5 of CC set 2; maps available slot indicator t6 to CC1 of CC set 3; maps available slot indicator t7 to CC4 of CC set 3; maps available slot indicator t1 to CC6 of CC set 4; maps available slot indicator t2 to CC7 of CC set 4; and maps available slot indicator t3 to CC8 of CC set 4.

In some examples, configuration table 410 may map CCs of a given CC set to TPC commands of a given block. In the provided example, configuration table 410 may map a TPC command 1 to CC1 of CC set 1; map a TPC command 2 to CC2 of CC set 1; and map a TPC command 3 to CC3 of CC set 1.

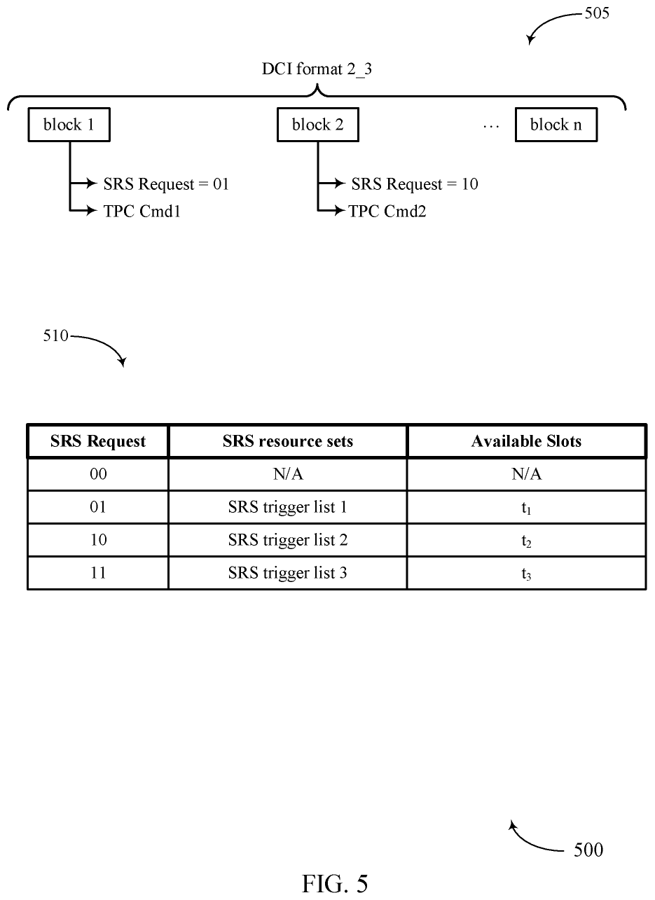

FIG. 5 illustrates an example of a Type-B signaling scheme 500 that supports using downlink control information to indicate an available reference signal slot in accordance with aspects of the present disclosure. In some cases, aspects of signaling scheme 500 may be performed by a UE (e.g., UE 115 as described herein) or a base station (e.g., base station 105 as described herein), or both.

In some examples, a configuration table 510 may be signaled to the UE via an RRC or MAC-CE configuration message prior to a DCI 505 triggering an SRS transmission by the UE. Configuration table 510 may provide an implicit way to indicate available slots indicators without adding any new field to DCI 505. In some cases, configuration table 510 may map a first available slot indicator to a first set of SRS resources block 1 of DCI 505, and map a second available slot indicator to a second set of SRS resources of block 2 of DCI 505, etc.

In the illustrated example, DCI 505 may include an SRS request with a 2-bit codepoint value of 01, 10, or 11 (e.g., no SRS requests with a 2-bit codepoint value of 00 for configuration table 510). In some cases, configuration table 510 maps available slot indicator t1 to SRS request 01; maps available slot indicator t2 to SRS request 10; and maps available slot indicator t3 to SRS request 11. Additionally, or alternatively, configuration table 510 maps available slot indicator t1 to a first set of SRS resources (e.g., SRS trigger list 1); maps available slot indicator t2 to a second set of SRS resources (e.g., SRS trigger list 2); and maps available slot indicator t3 to a third set of SRS resources (e.g., SRS trigger list 3).

In some examples, configuration table 510 may map a set of SRS resources to TPC commands of a given block. In the provided example, configuration table 510 may map a TPC command 1 of block 1 to the first set of SRS resources, and map TPC command 2 of block 2 to the second set of SRS resources. In some cases, block 1 may correspond to a first CC (e.g., ServCellIndex=3), block 2 may correspond to a second CC (e.g., ServCellIndex=1), and so forth. In some cases, configuration table 510 may map the first CC of block 1 to the first set of SRS resources, and map the second CC of block 2 to the second set of SRS resources. In some cases, the first CC may map to SRS request 01 and a first TPC command of block 1, while the second CC may map to SRS request 10 and a second TPC command of block 2, and so forth.

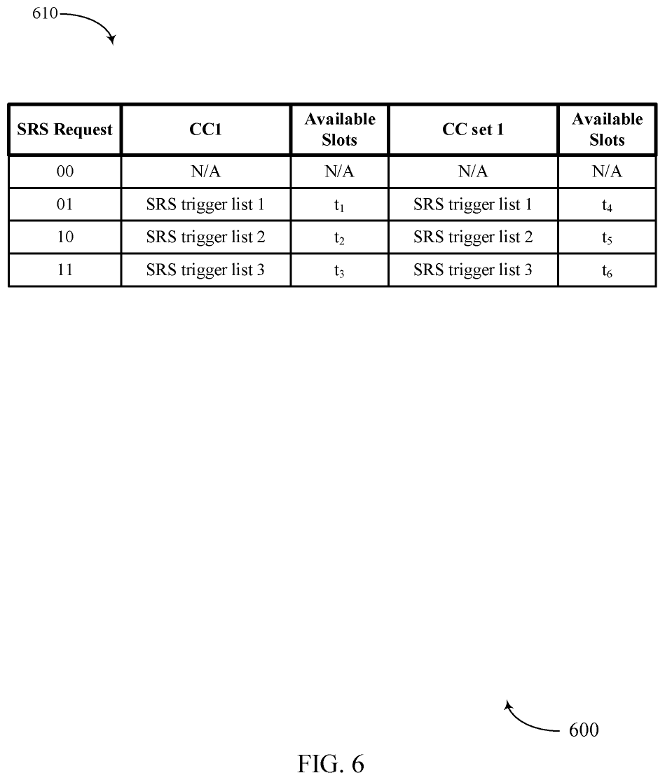

FIG. 6 illustrates an example of an alternative Type-B configuration table 610 that supports using downlink control information to indicate an available reference signal slot in accordance with aspects of the present disclosure. Configuration table 610 may be signaled to the UE via an RRC or MAC-CE configuration message. Configuration table 610 may be an alternative example of the configuration table 510 of FIG. 5, and provides an implicit way to indicate available slots indicators without adding any new field to a DCI (e.g., DCI 505). In the illustrated example, configuration table 610 maps available slot indicator t1 to SRS request 01; maps available slot indicator t2 to SRS request 10; and maps available slot indicator t3 to SRS request 11.

Additionally, or alternatively, configuration table 610 maps available slot indicator t1 to a first set of SRS resources (e.g., SRS trigger list 1); maps available slot indicator t2 to a second set of SRS resources (e.g., SRS trigger list 2); and maps available slot indicator t3 to a third set of SRS resources (e.g., SRS trigger list 3). In some cases, available slot indicators t1, t2, and t3 map to CC1.

Additionally, or alternatively, configuration table 610 maps available slot indicator t4 to the first set of SRS resources; maps available slot indicator t5 to the second set of SRS resources; and maps available slot indicator t6 to the third set of SRS resources. In some cases, available slot indicators t4, t5, and t6 map to CC set 1 (e.g., a set of CCs such as CC1, CC2, CC3, etc.). In some cases, available slot indicators t4, t5, and t6 map respectively to the CCs of CC set 1 (e.g., t4 maps to CC1, t5 maps to CC2, and t6 maps to CC3).

In some examples, configuration table 610 may map a set of SRS resources to TPC commands of a given block. In the provided example, configuration table 610 may map a TPC command 1 of a first block to the first set of SRS resources, and map a TPC command 2 of a second block to the second set of SRS resources, etc.

In some cases, the configuration of configuration table 610 may enable a base station to indicate the same available slot indicator for multiple UEs and the SRSs from the multiple UEs may be multiplexed at the same slot (e.g., demultiplexed by the base station for SRSs from the same slot). In some cases, the configuration of configuration table 610 may provide a UE with an index (e.g., pointer) to an available slot indicator (e.g., t1 may be configured as a pointer to an available slot). In some cases, the configuration of configuration table 610 may include two pointers for a given block, a first pointer pointing to a codepoint value for an SRS request or a TPC command, or both, and a second pointer pointing to an available slot.

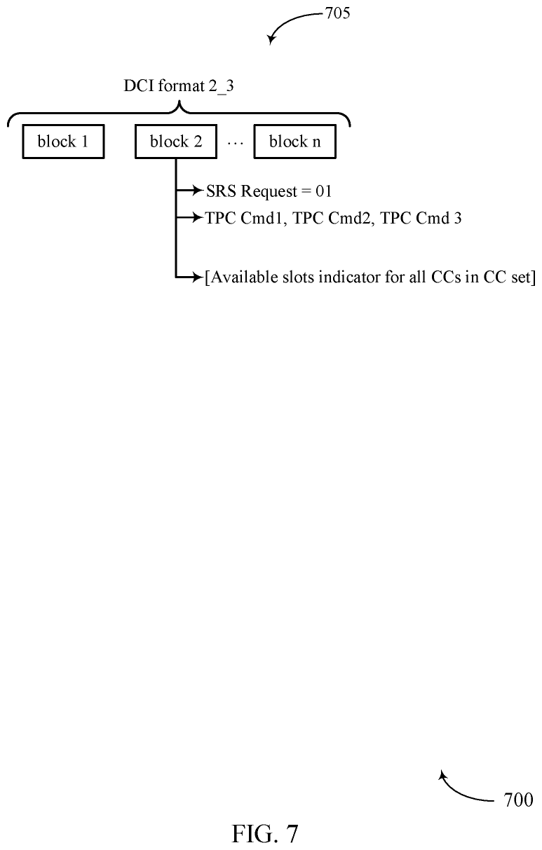

FIG. 7 illustrates an example of a Type-A signaling scheme 700 that supports using downlink control information to indicate an available reference signal slot in accordance with aspects of the present disclosure. In some cases, aspects of the signaling scheme 700 may be performed by a UE (e.g., UE 115 as described herein) or a base station (e.g., base station 105 as described herein), or both.

In some examples, the signaling scheme 700 may include a DCI 705 (e.g., downlink control message 220 of FIG. 2) used to trigger one or more SRS transmission by a UE. In some cases, DCI 705 may be a group common DCI (GC-DCI, type A GC-DCI).

DCI 705 provides an explicit way to indicate one available slots indicator per block by adding one or more new fields to DCI 705. In some cases, one or more blocks of DCI 705 may include a field for an available slot indicator. In the illustrated example, block 2 may include a field for an available slot indicator. The available slot indicator of block 2 may apply for all CCs in a CC set that corresponds to block 2.

In some cases, block 2 of DCI 705 may correspond to a CC set 1, which may include CC2, CC3, and CC4. In some cases, block 2 may include TPC command 1, TPC command 2, and TPC command 3. In some cases, TPC command 1 may correspond to CC2, TPC command 2 may correspond to CC3, and TPC command 3 may correspond to CC4. In some cases, the available slot indicator of block 2 may apply mutually to CC2, CC3, and CC4 (e.g., the same available slot indicator may correspond to all CCs of a given block).

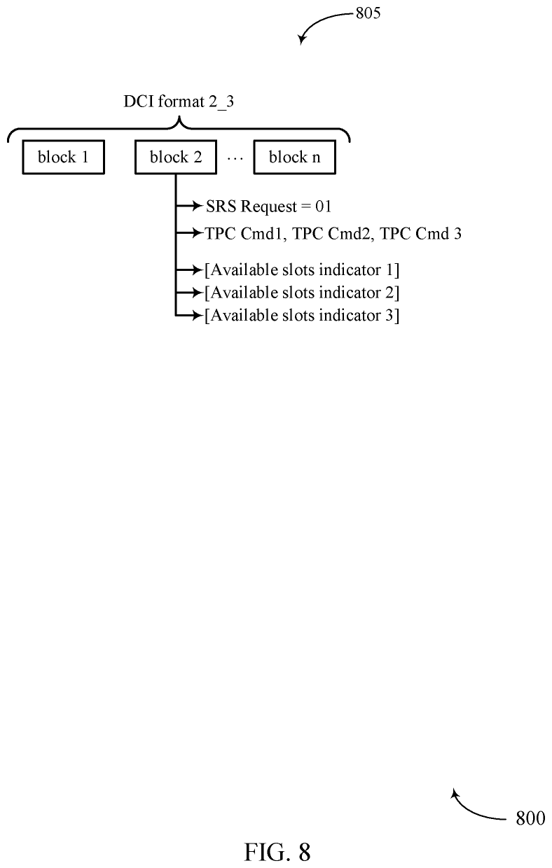

FIG. 8 illustrates an example of a Type-A signaling scheme 800 that supports using downlink control information to indicate an available reference signal slot in accordance with aspects of the present disclosure. In some cases, aspects of signaling scheme 800 may be performed by a UE (e.g., UE 115 as described herein) or a base station (e.g., base station 105 as described herein), or both.

In some examples, signaling scheme 800 may include DCI 805 (e.g., downlink control message 220 of FIG. 2) used to trigger an SRS transmission by a UE. In some cases, DCI 805 may be a group common DCI (GC-DCI, type A GC-DCI).

DCI 805 provides an explicit way to indicate multiple available slots indicators per block by adding one or more new fields to DCI 805. In some cases, one or more blocks of DCI 805 may include at least one field for an available slot indicator. In the illustrated example, block 2 may include a first field for a first available slot indicator, a second field for a second available slot indicator, and a third field for a third available slot indicator. In some cases, a single field may include the first available slot indicator, the second available slot indicator, and the third available slot indicator.

In some cases, block 2 of DCI 805 may correspond to a CC set 1, which may include CC2, CC3, and CC4. In some cases, block 2 may include TPC command 1, TPC command 2, and TPC command 3. In some cases, TPC command 1 may correspond to CC2, TPC command 2 may correspond to CC3, and TPC command 3 may correspond to CC4. In some cases, the first available slot indicator of block 2 may correspond to CC2, the second available slot indicator of block 2 may correspond to CC3, the third available slot indicator of block 2 may correspond to CC4, (e.g., each available slot indicator may correspond, respectively, to one CC of a CC set of a given block in a one-to-one correspondence).

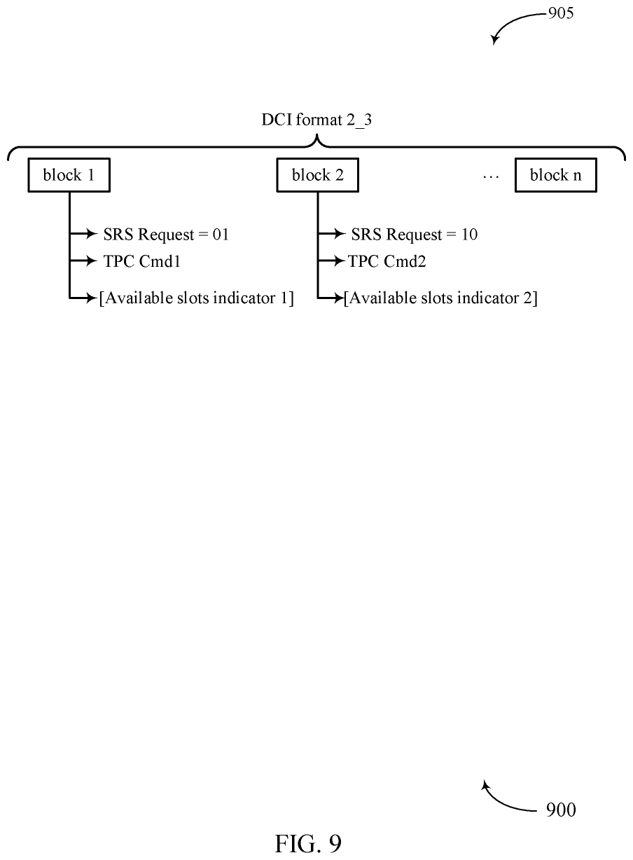

FIG. 9 illustrates an example of a Type-B signaling scheme 900 that supports using downlink control information to indicate an available reference signal slot in accordance with aspects of the present disclosure. In some cases, aspects of signaling scheme 900 may be performed by a UE (e.g., UE 115 as described herein) or a base station (e.g., base station 105 as described herein), or both.

In some examples, signaling scheme 900 may include a DCI 905 (e.g., downlink control message 220 of FIG. 2) used to trigger one or more SRS transmissions by a UE. In some cases, DCI 905 may be a group common DCI (GC-DCI, type A GC-DCI). As shown, DCI 905 depicts one or more aspects of configuration 900.

DCI 905 provides an explicit way to indicate one available slots indicator per block by adding one or more new fields to DCI 905. In some cases, one or more blocks of DCI 905 may include a field for an available slot indicator. In the illustrated example, block 1 may include a new field for a first available slot indicator, while block 2 may include a new field for a second available slot indicator, and so on.

In some examples, SRS request 01 of block 1 corresponds to a first set of SRS resources, while SRS request 10 of block 2 corresponds to a second set of SRS resources. In some cases, block 1 may correspond to a first CC (e.g., CC3), while block may correspond to a second CC (e.g., CC1). In the illustrated example, the first available slot indicator of block 1 may correspond to the first CC (e.g., CC3) of block 1, while the second available slot indicator may apply to the second CC (e.g., CC1) of block 2. In some cases, a first TPC command of block 1 may correspond to the first CC (e.g., CC3) of block 1, while a second TPC command of block 2 may correspond to the second CC (e.g., CC1) of block 2.

In some cases, the available slot field of block 1 or block 2 may include a value that corresponds to the available slot or may include a pointer that points to the available slot. In some cases, a field of a block of DCI 905 (e.g., SRS request field, TPC command field, etc.) may include a second pointer that points to the corresponding SRS request or points to the TPC command, or both.

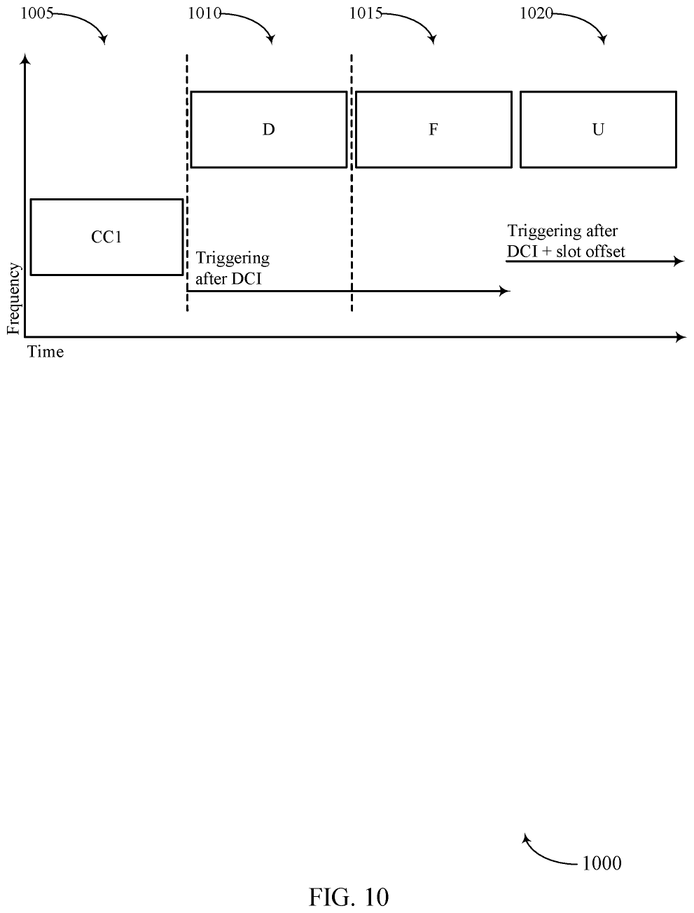

FIG. 10 illustrates an example of a scheduling 1000 that supports using downlink control information to indicate an available reference signal slot in accordance with aspects of the present disclosure. In the illustrated example, scheduling 1000 may depict time-domain resources or frequency-domain resources, or both, associated with indicating available slots for reference signal transmissions.

As shown, scheduling 1000 may include a first component carrier (CC1) 1005 associated with a DCI (e.g., a DCI described herein), followed by a downlink slot 1010 (e.g., a slot with downlink resources in time and/or frequency), a flexible slot 1015 (e.g., a slot with flexible resources in time and/or frequency), and an uplink slot 1020 (e.g., a slot with uplink resources in time and/or frequency).

In some examples, an available slot may be indicated by an available slot indicator. In some cases, an available slot may be indicated by an available slot indicator and a reference slot. In some cases, the reference slot may be measured from a DCI (e.g., triggered after a DCI as shown), or the reference slot may be measured from a combination of the DCI and a slot offset value, or the reference slot may be measured from a first slot available after a UE performs a component carrier switching procedure (e.g., from a first component carrier to a second component carrier, or any combination thereof.

In some examples, an available slot indicator may indicate at least one slot that includes uplink resources or flexible resources that are configurable as uplink resources. In some cases, an available slot may be a slot where there are one or more uplink or flexible symbols for time-domain locations for all the SRS resources in a resource set and where a minimum timing constraint between triggering PDCCH and all the SRS resources in the resource set. In some cases, an aperiodic SRS resource set may be transmitted in the (t+1)-th available slot counting from a reference slot, where t is indicated from a DCI (or RRC when only one value of t is configured), and the candidate values oft include at least 0. In some examples, a slot offset from 1 to 32 may be indicated by a value in a field of a DCI. In some cases, the UE may determine the slot offset is 0 when the UE determines this field has been omitted from the DCI.

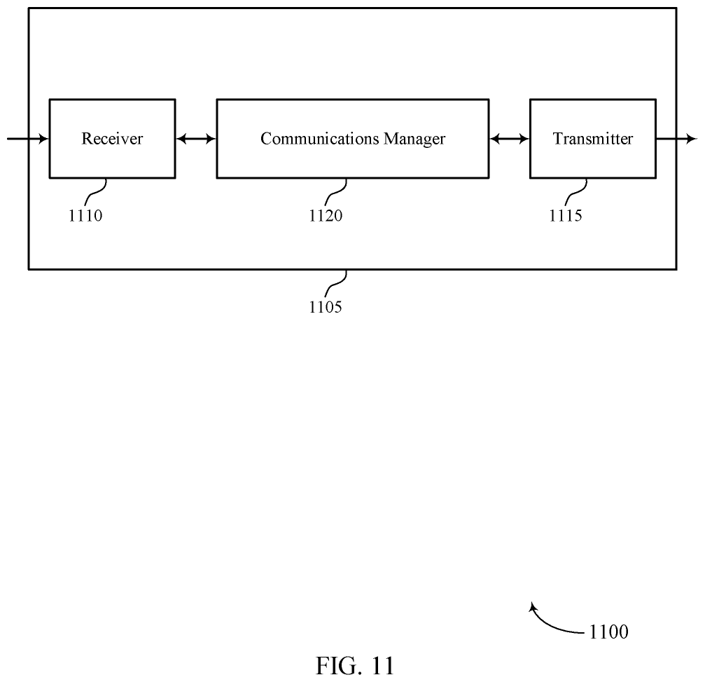

FIG. 11 shows a block diagram 1100 of a device 1105 that supports reference signal available slot indication by group common downlink control information in accordance with aspects of the present disclosure. The device 1105 may be an example of aspects of a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to reference signal available slot indication by group common downlink control information). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to reference signal available slot indication by group common downlink control information). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of reference signal available slot indication by group common downlink control information as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 1120 may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a UE in accordance with examples as disclosed herein. For example, the communications manager 1120 may be configured as or otherwise support a means for receiving, from a base station, control information identifying a configuration for transmission of an aperiodic sounding reference signal. The communications manager 1120 may be configured as or otherwise support a means for receiving, from the base station, a downlink control message including a set of one or more blocks, where each block of the one or more blocks includes a sounding reference signal request in accordance with the configuration for transmission of an aperiodic sounding reference signal, an indication of an available slot corresponding to that block, and one or more transmit power control commands. The communications manager 1120 may be configured as or otherwise support a means for transmitting, during the available slot corresponding to a block of the set of one or more blocks, the aperiodic sounding reference signal in accordance with a power level indicated by the one or more transmit power control commands corresponding to the block.

By including or configuring the communications manager 1120 in accordance with examples as described herein, the device 1105 (e.g., a processor controlling or otherwise coupled to the receiver 1110, the transmitter 1115, the communications manager 1120, or a combination thereof) may support techniques for providing indications of available slots by group common downlink control information. Providing indications of available slots results in higher system efficiency such that latencies associated with devices transmitting reference signals based on the indications are reduced. Additionally, described techniques may result in reduced processing, reduced power consumption, more efficient utilization of communication resources.

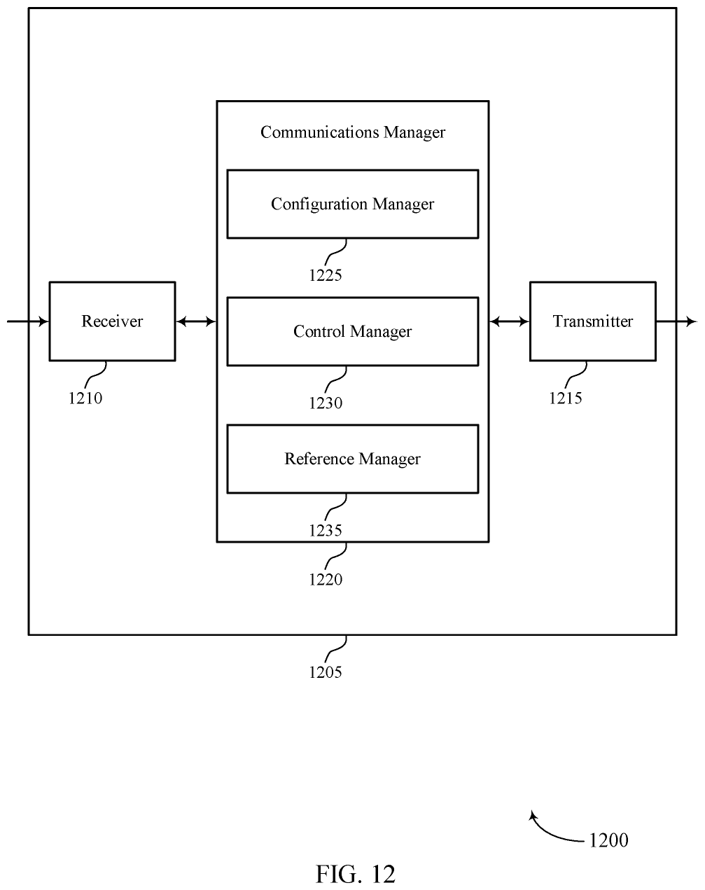

FIG. 12 shows a block diagram 1200 of a device 1205 that supports reference signal available slot indication by group common downlink control information in accordance with aspects of the present disclosure. The device 1205 may be an example of aspects of a device 1105 or a UE 115 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to reference signal available slot indication by group common downlink control information). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to reference signal available slot indication by group common downlink control information). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of reference signal available slot indication by group common downlink control information as described herein. For example, the communications manager 1220 may include a configuration manager 1225, a control manager 1230, a reference manager 1235, or any combination thereof. The communications manager 1220 may be an example of aspects of a communications manager 1120 as described herein. In some examples, the communications manager 1220, or various components thereof, may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communication at a UE in accordance with examples as disclosed herein. The configuration manager 1225 may be configured as or otherwise support a means for receiving, from a base station, control information identifying a configuration for transmission of an aperiodic sounding reference signal. The control manager 1230 may be configured as or otherwise support a means for receiving, from the base station, a downlink control message including a set of one or more blocks, where each block of the one or more blocks includes a sounding reference signal request in accordance with the configuration for transmission of an aperiodic sounding reference signal, an indication of an available slot corresponding to that block, and one or more transmit power control commands. The reference manager 1235 may be configured as or otherwise support a means for transmitting, during the available slot corresponding to a block of the set of one or more blocks, the aperiodic sounding reference signal in accordance with a power level indicated by the one or more transmit power control commands corresponding to the block.

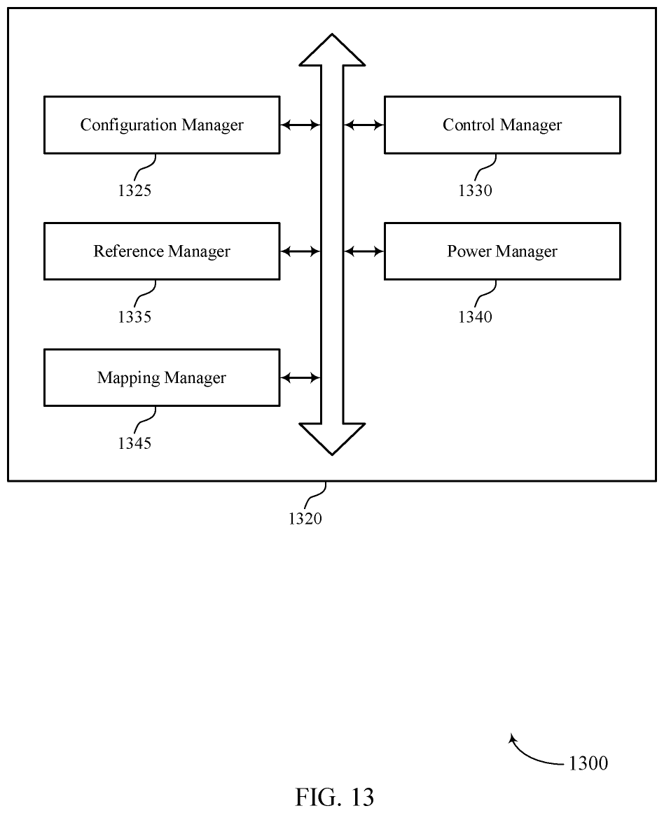

FIG. 13 shows a block diagram 1300 of a communications manager 1320 that supports reference signal available slot indication by group common downlink control information in accordance with aspects of the present disclosure. The communications manager 1320 may be an example of aspects of a communications manager 1120, a communications manager 1220, or both, as described herein. The communications manager 1320, or various components thereof, may be an example of means for performing various aspects of reference signal available slot indication by group common downlink control information as described herein. For example, the communications manager 1320 may include a configuration manager 1325, a control manager 1330, a reference manager 1335, a power manager 1340, a mapping manager 1345, or any combination thereof. Each of these components may communicate, directly or indirectly, with one another (e.g., via one or more buses).

The communications manager 1320 may support wireless communication at a UE in accordance with examples as disclosed herein. The configuration manager 1325 may be configured as or otherwise support a means for receiving, from a base station, control information identifying a configuration for transmission of an aperiodic sounding reference signal. The control manager 1330 may be configured as or otherwise support a means for receiving, from the base station, a downlink control message including a set of one or more blocks, where each block of the one or more blocks includes a sounding reference signal request in accordance with the configuration for transmission of an aperiodic sounding reference signal, an indication of an available slot corresponding to that block, and one or more transmit power control commands. The reference manager 1335 may be configured as or otherwise support a means for transmitting, during the available slot corresponding to a block of the set of one or more blocks, the aperiodic sounding reference signal in accordance with a power level indicated by the one or more transmit power control commands corresponding to the block.

In some examples, the configuration manager 1325 may be configured as or otherwise support a means for identifying, based on the configuration, a set of uplink component carriers that correspond to the block.

In some examples, to support transmitting the aperiodic sounding reference signal during the identified slot, the configuration manager 1325 may be configured as or otherwise support a means for transmitting the aperiodic sounding reference signal on each component carrier of the set of uplink component carriers corresponding to the block.

In some examples, the configuration manager 1325 may be configured as or otherwise support a means for identifying, based on the configuration, a first component carrier of the set of uplink component carriers that corresponds to a first transmit power control command of the one or more transmit power control commands and a second component carrier of the set of uplink component carriers that corresponds to a second transmit power control command of the one or more transmit power control commands.

In some examples, to support transmitting the aperiodic sounding reference signal during the identified slot, the configuration manager 1325 may be configured as or otherwise support a means for transmitting the aperiodic sounding reference signal on the first component carrier at a first power level indicated by the first transmit power control command, and transmitting the aperiodic sounding reference signal on the second component carrier at a second power level indicated by the second transmit power control command, where the second power level is different than or equal to the first power level.

In some examples, the power manager 1340 may be configured as or otherwise support a means for identifying, based on the configuration, a component carrier that corresponds to the block, where the component carrier corresponds to a transmit power control command of the one or more transmit power control commands. In some examples, the power manager 1340 may be configured as or otherwise support a means for transmitting the aperiodic sounding reference signal on the component carrier at a power level indicated by the transmit power control command.

In some examples, the mapping manager 1345 may be configured as or otherwise support a means for identifying, based on the configuration, a mapping between the sounding reference signal request and the indication of an available slot, and that a set of sounding reference signal resources corresponds to the sounding reference signal request.

In some examples, the mapping manager 1345 may be configured as or otherwise support a means for identifying, based on the configuration, a component carrier that corresponds to the set of sounding reference signal resources, where the component carrier corresponds to a transmit power control command of the one or more transmit power control commands. In some examples, the mapping manager 1345 may be configured as or otherwise support a means for using the set of sounding reference signal resources to transmit the aperiodic sounding reference signal on the component carrier at a power level indicated by the transmit power control command.

In some examples, the mapping manager 1345 may be configured as or otherwise support a means for identifying, based on the configuration, a set of multiple component carriers that correspond to the set of sounding reference signal resources, where the set of multiple component carriers corresponds to a transmit power control command of the one or more transmit power control commands, where each of the set of multiple component carriers point to the block. In some examples, the mapping manager 1345 may be configured as or otherwise support a means for using the set of sounding reference signal resources to transmit, during the identified slot, the aperiodic sounding reference signal on each of the set of multiple component carriers at a power level indicated by the transmit power control command.

In some examples, the configuration manager 1325 may be configured as or otherwise support a means for identifying the indication of the available slot based on the configuration, where the configuration maps the indication of the available slot to the block.

In some examples, the configuration manager 1325 may be configured as or otherwise support a means for identifying a second indication of one or more available slots in an available slots field of a second block.

In some examples, the configuration or the downlink control message, or both, include a first pointer associated with a third block that points to a third indication of one or more available slots. In some examples, the configuration or the downlink control message, or both, include a second pointer associated with the third block that points to a sounding reference signal request and one or more transmit power control commands of the third block.

In some examples, the configuration manager 1325 may be configured as or otherwise support a means for identifying a first component carrier of a set of uplink component carriers associated with the block that corresponds to the indication of the available slot and a second component carrier of the set of uplink component carriers that corresponds to a second indication of one or more available slots, where the available slots field of the block includes the second indication of the one or more available slots.

In some examples, the indication of the available slot includes a slot offset value. In some examples, identifying the slot includes identifying the slot based on the slot offset value.

In some examples, to support identifying the slot, the configuration manager 1325 may be configured as or otherwise support a means for identifying the slot based on a reference slot indicated by the configuration or the downlink control message, or indicated by both, where the reference slot is measured from the downlink control message, or from a combination of the downlink control message and a slot offset value, or a first slot available after the UE performs a component carrier switching procedure, or any combination thereof.

In some examples, the configuration manager 1325 may be configured as or otherwise support a means for receiving a list of index values in the configuration, or in a message from the base station, where the configuration includes an index value that maps to an entry of the list of index values, where the entry of the list of index values indicates the available slot that corresponds to the block.

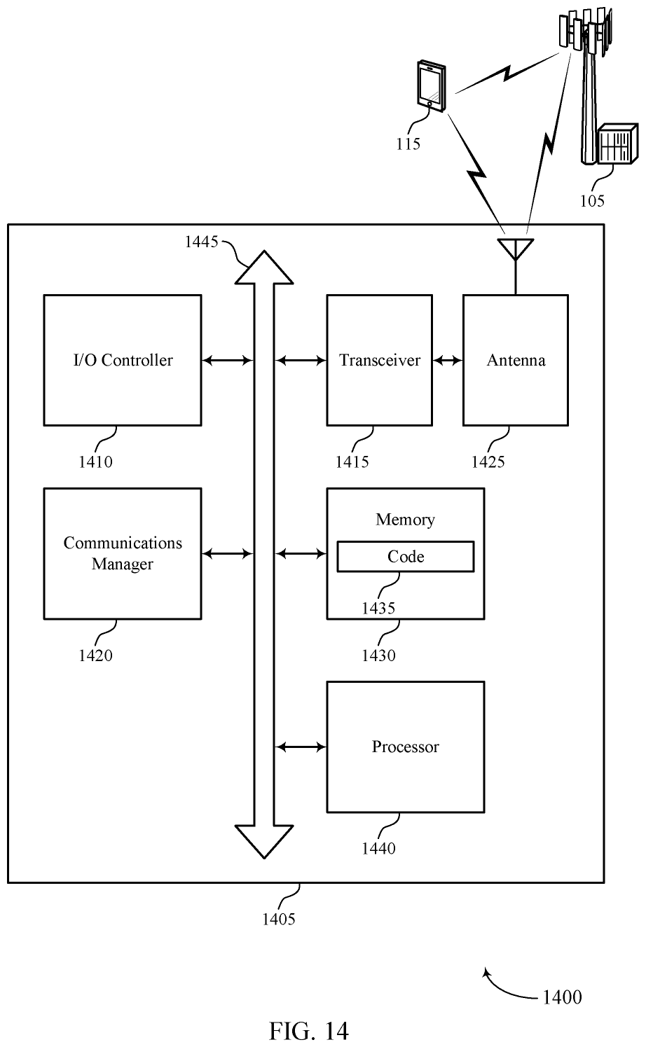

FIG. 14 shows a diagram of a system 1400 including a device 1405 that supports reference signal available slot indication by group common downlink control information in accordance with aspects of the present disclosure. The device 1405 may be an example of or include the components of a device 1105, a device 1205, or a UE 115 as described herein. The device 1405 may communicate wirelessly with one or more base stations 105, UEs 115, or any combination thereof. The device 1405 may include components for bi-directional voice and data communications including components for transmitting and receiving communications, such as a communications manager 1420, an input/output (I/O) controller 1410, a transceiver 1415, an antenna 1425, a memory 1430, code 1435, and a processor 1440. These components may be in electronic communication or otherwise coupled (e.g., operatively, communicatively, functionally, electronically, electrically) via one or more buses (e.g., a bus 1445).

The I/O controller 1410 may manage input and output signals for the device 1405. The I/O controller 1410 may also manage peripherals not integrated into the device 1405. In some cases, the I/O controller 1410 may represent a physical connection or port to an external peripheral. In some cases, the I/O controller 1410 may utilize an operating system such as iOS®, ANDROID®, MS-DOS®, MS-WINDOWS®, OS/2®, UNIX®, LINUX®, or another known operating system. Additionally or alternatively, the I/O controller 1410 may represent or interact with a modem, a keyboard, a mouse, a touchscreen, or a similar device. In some cases, the I/O controller 1410 may be implemented as part of a processor, such as the processor 1440. In some cases, a user may interact with the device 1405 via the I/O controller 1410 or via hardware components controlled by the I/O controller 1410.

In some cases, the device 1405 may include a single antenna 1425. However, in some other cases, the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include random access memory (RAM) and read-only memory (ROM). The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a basic I/O system (BIOS) which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting reference signal available slot indication by group common downlink control information). For example, the device 1405 or a component of the device 1405 may include a processor 1440 and memory 1430 coupled to the processor 1440, the processor 1440 and memory 1430 configured to perform various functions described herein.

The communications manager 1420 may support wireless communication at a UE in accordance with examples as disclosed herein. For example, the communications manager 1420 may be configured as or otherwise support a means for receiving, from a base station, control information identifying a configuration for transmission of an aperiodic sounding reference signal. The communications manager 1420 may be configured as or otherwise support a means for receiving, from the base station, a downlink control message including a set of one or more blocks, where each block of the one or more blocks includes a sounding reference signal request in accordance with the configuration for transmission of an aperiodic sounding reference signal, an indication of an available slot corresponding to that block, and one or more transmit power control commands. The communications manager 1420 may be configured as or otherwise support a means for transmitting, during the available slot corresponding to a block of the set of one or more blocks, the aperiodic sounding reference signal in accordance with a power level indicated by the one or more transmit power control commands corresponding to the block.

By including or configuring the communications manager 1420 in accordance with examples as described herein, the device 1405 may support techniques for providing indications of available slots for reference signal transmissions such that latencies associated with devices transmitting reference signal transmissions are reduced. Additionally, described techniques may result in improved communication reliability, reduced latency, improved user experience related to reduced processing, reduced power consumption, more efficient utilization of communication resources, improved coordination between devices, longer battery life, improved utilization of processing capability.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of reference signal available slot indication by group common downlink control information as described herein, or the processor 1440 and the memory 1430 may be otherwise configured to perform or support such operations.

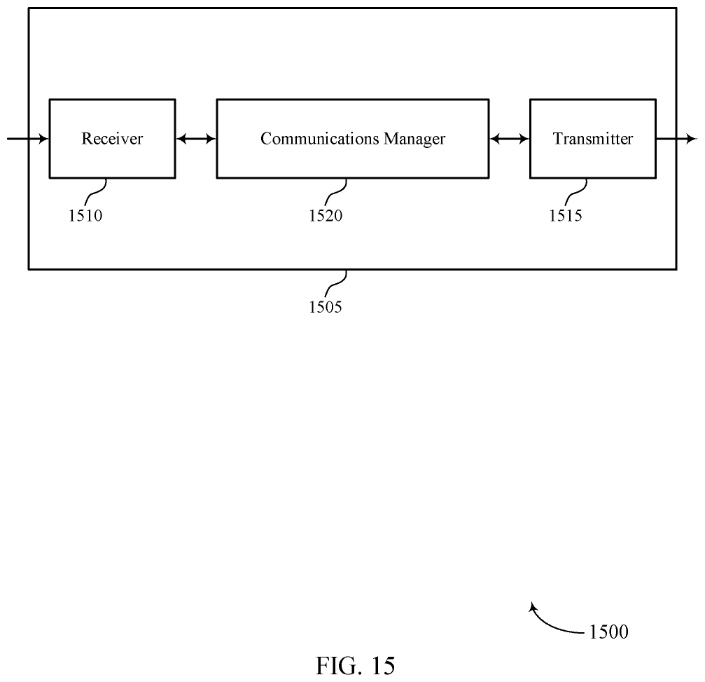

FIG. 15 shows a block diagram 1500 of a device 1505 that supports reference signal available slot indication by group common downlink control information in accordance with aspects of the present disclosure. The device 1505 may be an example of aspects of a base station 105 as described herein. The device 1505 may include a receiver 1510, a transmitter 1515, and a communications manager 1520. The device 1505 may also include a processor. Each of these components may be in communication with one another (e.g., via one or more buses).

The receiver 1510 may provide a means for receiving information such as packets, user data, control information, or any combination thereof associated with various information channels (e.g., control channels, data channels, information channels related to reference signal available slot indication by group common downlink control information). Information may be passed on to other components of the device 1505. The receiver 1510 may utilize a single antenna or a set of multiple antennas.

The transmitter 1515 may provide a means for transmitting signals generated by other components of the device 1505. For example, the transmitter 1515 may transmit information such as packets, user data, control information, or any combination thereof associated with various information channels (e.g., control channels, data channels, information channels related to reference signal available slot indication by group common downlink control information). In some examples, the transmitter 1515 may be co-located with a receiver 1510 in a transceiver module. The transmitter 1515 may utilize a single antenna or a set of multiple antennas.

The communications manager 1520, the receiver 1510, the transmitter 1515, or various combinations thereof or various components thereof may be examples of means for performing various aspects of reference signal available slot indication by group common downlink control information as described herein. For example, the communications manager 1520, the receiver 1510, the transmitter 1515, or various combinations or components thereof may support a method for performing one or more of the functions described herein.

In some examples, the communications manager 1520, the receiver 1510, the transmitter 1515, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1520, the receiver 1510, the transmitter 1515, or various combinations or components thereof may be implemented in code (e.g., as communications management software or firmware) executed by a processor. If implemented in code executed by a processor, the functions of the communications manager 1520, the receiver 1510, the transmitter 1515, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1520 may be configured to perform various operations (e.g., receiving, monitoring, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to receive information, transmit information, or perform various other operations as described herein.

The communications manager 1520 may support wireless communication at a base station in accordance with examples as disclosed herein. For example, the communications manager 1520 may be configured as or otherwise support a means for transmitting, to a UE, control information identifying a configuration for transmission of an aperiodic sounding reference signal. The communications manager 1520 may be configured as or otherwise support a means for transmitting, to the UE, a downlink control message including a set of one or more blocks, where each block of the one or more blocks includes a sounding reference signal request in accordance with the configuration for transmission of an aperiodic sounding reference signal, an indication of an available slot corresponding to that block, and one or more transmit power control commands. The communications manager 1520 may be configured as or otherwise support a means for receiving, from the UE during the available slot corresponding to a block of the set of one or more blocks, the aperiodic sounding reference signal in accordance with a power level indicated by the one or more transmit power control commands corresponding to the block.

By including or configuring the communications manager 1520 in accordance with examples as described herein, the device 1505 (e.g., a processor controlling or otherwise coupled to the receiver 1510, the transmitter 1515, the communications manager 1520, or a combination thereof) may support techniques for providing indications of available slots by group common downlink control information. Providing indications of available slots results in higher system efficiency such that latencies associated with devices transmitting reference signals based on the indications are reduced. Additionally, described techniques may result in reduced processing, reduced power consumption, more efficient utilization of communication resources.

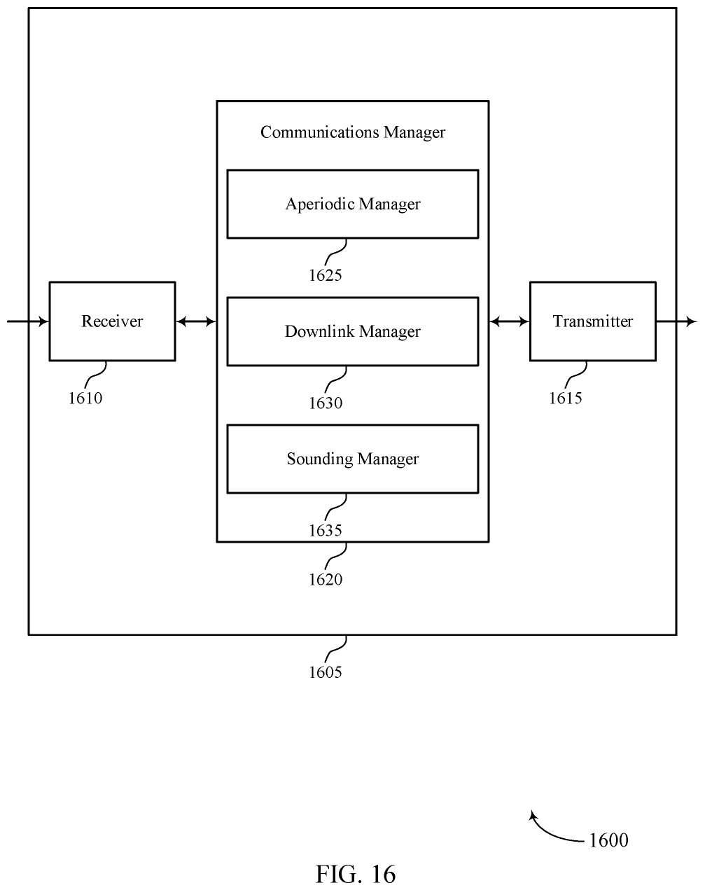

FIG. 16 shows a block diagram 1600 of a device 1605 that supports reference signal available slot indication by group common downlink control information in accordance with aspects of the present disclosure. The device 1605 may be an example of aspects of a device 1505 or a base station 105 as described herein. The device 1605 may include a receiver 1610, a transmitter 1615, and a communications manager 1620. The device 1605 may also include a processor. Each of these components may be in communication with one another (e.g., via one or more buses).

The receiver 1610 may provide a means for receiving information such as packets, user data, control information, or any combination thereof associated with various information channels (e.g., control channels, data channels, information channels related to reference signal available slot indication by group common downlink control information). Information may be passed on to other components of the device 1605. The receiver 1610 may utilize a single antenna or a set of multiple antennas.

The transmitter 1615 may provide a means for transmitting signals generated by other components of the device 1605. For example, the transmitter 1615 may transmit information such as packets, user data, control information, or any combination thereof associated with various information channels (e.g., control channels, data channels, information channels related to reference signal available slot indication by group common downlink control information). In some examples, the transmitter 1615 may be co-located with a receiver 1610 in a transceiver module. The transmitter 1615 may utilize a single antenna or a set of multiple antennas.

The device 1605, or various components thereof, may be an example of means for performing various aspects of reference signal available slot indication by group common downlink control information as described herein. For example, the communications manager 1620 may include an aperiodic manager 1625, a downlink manager 1630, a sounding manager 1635, or any combination thereof. The communications manager 1620 may be an example of aspects of a communications manager 1520 as described herein. In some examples, the communications manager 1620, or various components thereof, may be configured to perform various operations (e.g., receiving, monitoring, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to receive information, transmit information, or perform various other operations as described herein.

The communications manager 1620 may support wireless communication at a base station in accordance with examples as disclosed herein. The aperiodic manager 1625 may be configured as or otherwise support a means for transmitting, to a UE, control information identifying a configuration for transmission of an aperiodic sounding reference signal. The downlink manager 1630 may be configured as or otherwise support a means for transmitting, to the UE, a downlink control message including a set of one or more blocks, where each block of the one or more blocks includes a sounding reference signal request in accordance with the configuration for transmission of an aperiodic sounding reference signal, an indication of an available slot corresponding to that block, and one or more transmit power control commands. The sounding manager 1635 may be configured as or otherwise support a means for receiving, from the UE during the available slot corresponding to a block of the set of one or more blocks, the aperiodic sounding reference signal in accordance with a power level indicated by the one or more transmit power control commands corresponding to the block.

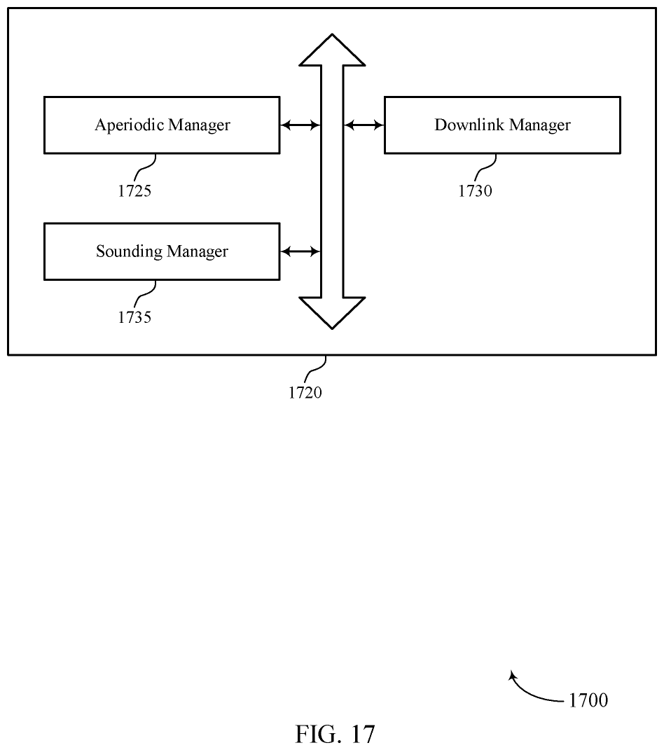

FIG. 17 shows a block diagram 1700 of a communications manager 1720 that supports reference signal available slot indication by group common downlink control information in accordance with aspects of the present disclosure. The communications manager 1720 may be an example of aspects of a communications manager 1520, a communications manager 1620, or both, as described herein. The communications manager 1720, or various components thereof, may be an example of means for performing various aspects of reference signal available slot indication by group common downlink control information as described herein. For example, the communications manager 1720 may include an aperiodic manager 1725, a downlink manager 1730, a sounding manager 1735, or any combination thereof. Each of these components may communicate, directly or indirectly, with one another (e.g., via one or more buses).

The communications manager 1720 may support wireless communication at a base station in accordance with examples as disclosed herein. The aperiodic manager 1725 may be configured as or otherwise support a means for transmitting, to a UE, control information identifying a configuration for transmission of an aperiodic sounding reference signal. The downlink manager 1730 may be configured as or otherwise support a means for transmitting, to the UE, a downlink control message including a set of one or more blocks, where each block of the one or more blocks includes a sounding reference signal request in accordance with the configuration for transmission of an aperiodic sounding reference signal, an indication of an available slot corresponding to that block, and one or more transmit power control commands. The sounding manager 1735 may be configured as or otherwise support a means for receiving, from the UE during the available slot corresponding to a block of the set of one or more blocks, the aperiodic sounding reference signal in accordance with a power level indicated by the one or more transmit power control commands corresponding to the block.

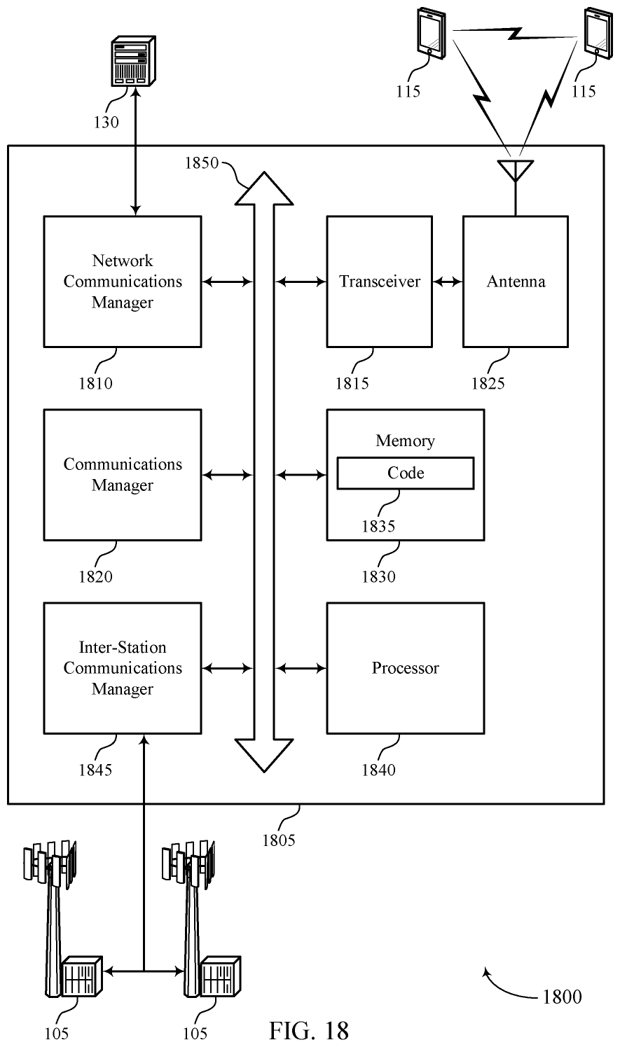

FIG. 18 shows a diagram of a system 1800 including a device 1805 that supports reference signal available slot indication by group common downlink control information in accordance with aspects of the present disclosure. The device 1805 may be an example of or include the components of a device 1505, a device 1605, or a base station 105 as described herein. The device 1805 may communicate wirelessly with one or more base stations 105, UEs 115, or any combination thereof. The device 1805 may include components for bi-directional voice and data communications including components for transmitting and receiving communications, such as a communications manager 1820, a network communications manager 1810, a transceiver 1815, an antenna 1825, a memory 1830, code 1835, a processor 1840, and an inter-station communications manager 1845. These components may be in electronic communication or otherwise coupled (e.g., operatively, communicatively, functionally, electronically, electrically) via one or more buses (e.g., a bus 1850).

The network communications manager 1810 may manage communications with a core network 130 (e.g., via one or more wired backhaul links). For example, the network communications manager 1810 may manage the transfer of data communications for client devices, such as one or more UEs 115.

In some cases, the device 1805 may include a single antenna 1825. However, in some other cases the device 1805 may have more than one antenna 1825, which may be capable of concurrently transmitting or receiving multiple wireless transmissions. The transceiver 1815 may communicate bi-directionally, via the one or more antennas 1825, wired, or wireless links as described herein. For example, the transceiver 1815 may represent a wireless transceiver and may communicate bi-directionally with another wireless transceiver. The transceiver 1815 may also include a modem to modulate the packets, to provide the modulated packets to one or more antennas 1825 for transmission, and to demodulate packets received from the one or more antennas 1825. The transceiver 1815, or the transceiver 1815 and one or more antennas 1825, may be an example of a transmitter 1515, a transmitter 1615, a receiver 1510, a receiver 1610, or any combination thereof or component thereof, as described herein.

The memory 1830 may include RANI and ROM. The memory 1830 may store computer-readable, computer-executable code 1835 including instructions that, when executed by the processor 1840, cause the device 1805 to perform various functions described herein. The code 1835 may be stored in a non-transitory computer-readable medium such as system memory or another type of memory. In some cases, the code 1835 may not be directly executable by the processor 1840 but may cause a computer (e.g., when compiled and executed) to perform functions described herein. In some cases, the memory 1830 may contain, among other things, a BIOS which may control basic hardware or software operation such as the interaction with peripheral components or devices.

The processor 1840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1840 may be configured to operate a memory array using a memory controller. In some other cases, a memory controller may be integrated into the processor 1840. The processor 1840 may be configured to execute computer-readable instructions stored in a memory (e.g., the memory 1830) to cause the device 1805 to perform various functions (e.g., functions or tasks supporting reference signal available slot indication by group common downlink control information). For example, the device 1805 or a component of the device 1805 may include a processor 1840 and memory 1830 coupled to the processor 1840, the processor 1840 and memory 1830 configured to perform various functions described herein.

The inter-station communications manager 1845 may manage communications with other base stations 105, and may include a controller or scheduler for controlling communications with UEs 115 in cooperation with other base stations 105. For example, the inter-station communications manager 1845 may coordinate scheduling for transmissions to UEs 115 for various interference mitigation techniques such as beamforming or joint transmission. In some examples, the inter-station communications manager 1845 may provide an X2 interface within an LTE/LTE-A wireless communications network technology to provide communication between base stations 105.

The communications manager 1820 may support wireless communication at a base station in accordance with examples as disclosed herein. For example, the communications manager 1820 may be configured as or otherwise support a means for transmitting, to a UE, control information identifying a configuration for transmission of an aperiodic sounding reference signal. The communications manager 1820 may be configured as or otherwise support a means for transmitting, to the UE, a downlink control message including a set of one or more blocks, where each block of the one or more blocks includes a sounding reference signal request in accordance with the configuration for transmission of an aperiodic sounding reference signal, an indication of an available slot corresponding to that block, and one or more transmit power control commands. The communications manager 1820 may be configured as or otherwise support a means for receiving, from the UE during the available slot corresponding to a block of the set of one or more blocks, the aperiodic sounding reference signal in accordance with a power level indicated by the one or more transmit power control commands corresponding to the block.

By including or configuring the communications manager 1820 in accordance with examples as described herein, the device 1805 may support techniques for providing indications of available slots for reference signal transmissions such that latencies associated with devices transmitting reference signal transmissions are reduced. Additionally, described techniques may result in improved communication reliability, reduced latency, improved user experience related to reduced processing, reduced power consumption, more efficient utilization of communication resources, improved coordination between devices, longer battery life, improved utilization of processing capability.

In some examples, the communications manager 1820 may be configured to perform various operations (e.g., receiving, monitoring, transmitting) using or otherwise in cooperation with the transceiver 1815, the one or more antennas 1825, or any combination thereof. Although the communications manager 1820 is illustrated as a separate component, in some examples, one or more functions described with reference to the communications manager 1820 may be supported by or performed by the processor 1840, the memory 1830, the code 1835, or any combination thereof. For example, the code 1835 may include instructions executable by the processor 1840 to cause the device 1805 to perform various aspects of reference signal available slot indication by group common downlink control information as described herein, or the processor 1840 and the memory 1830 may be otherwise configured to perform or support such operations.

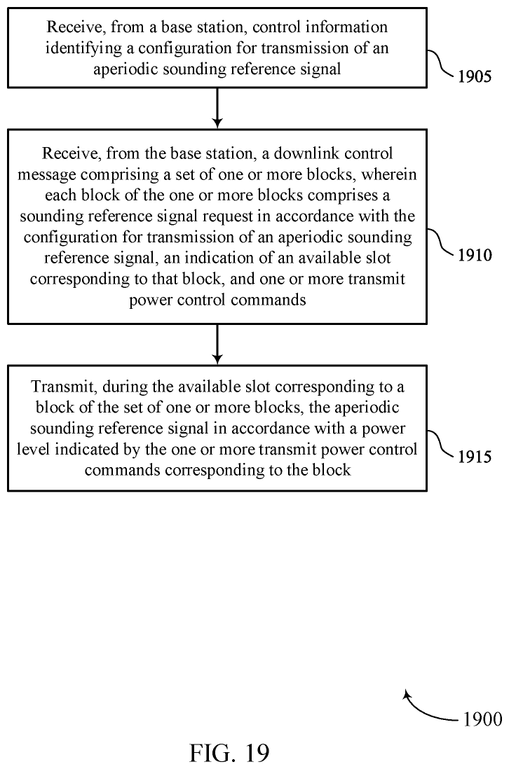

FIG. 19 shows a flowchart illustrating a method 1900 that supports reference signal available slot indication by group common downlink control information in accordance with aspects of the present disclosure. The operations of the method 1900 may be implemented by a UE or its components as described herein. For example, the operations of the method 1900 may be performed by a UE 115 as described with reference to FIGS. 1 through 14. In some examples, a UE may execute a set of instructions to control the functional elements of the UE to perform the described functions. Additionally or alternatively, the UE may perform aspects of the described functions using special-purpose hardware.

At 1905, the method may include receiving, from a base station, control information identifying a configuration for transmission of an aperiodic sounding reference signal. The operations of 1905 may be performed in accordance with examples as disclosed herein. In some examples, aspects of the operations of 1905 may be performed by a configuration manager 1325 as described with reference to FIG. 13.

At 1910, the method may include receiving, from the base station, a downlink control message including a set of one or more blocks, where each block of the one or more blocks includes a sounding reference signal request in accordance with the configuration for transmission of an aperiodic sounding reference signal, an indication of an available slot corresponding to that block, and one or more transmit power control commands. The operations of 1910 may be performed in accordance with examples as disclosed herein. In some examples, aspects of the operations of 1910 may be performed by a control manager 1330 as described with reference to FIG. 13.

At 1915, the method may include transmitting, during the available slot corresponding to a block of the set of one or more blocks, the aperiodic sounding reference signal in accordance with a power level indicated by the one or more transmit power control commands corresponding to the block. The operations of 1915 may be performed in accordance with examples as disclosed herein. In some examples, aspects of the operations of 1915 may be performed by a reference manager 1335 as described with reference to FIG. 13.

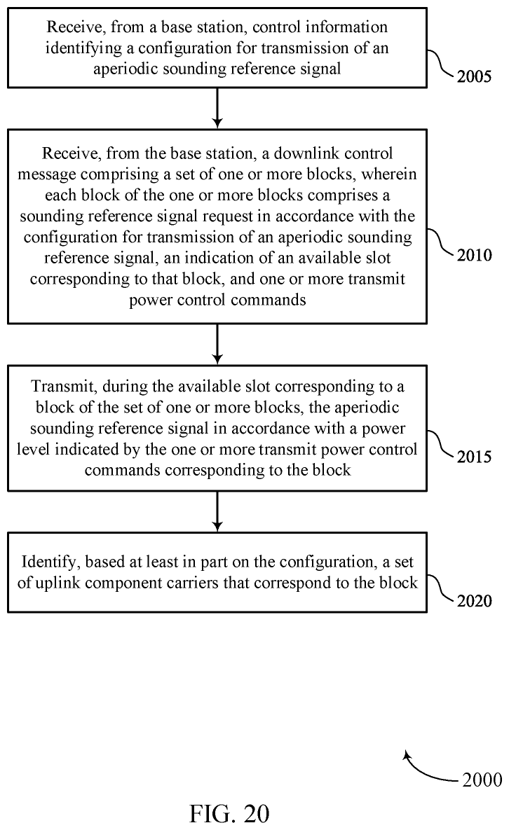

FIG. 20 shows a flowchart illustrating a method 2000 that supports reference signal available slot indication by group common downlink control information in accordance with aspects of the present disclosure. The operations of the method 2000 may be implemented by a UE or its components as described herein. For example, the operations of the method 2000 may be performed by a UE 115 as described with reference to FIGS. 1 through 14. In some examples, a UE may execute a set of instructions to control the functional elements of the UE to perform the described functions. Additionally or alternatively, the UE may perform aspects of the described functions using special-purpose hardware.

At 2005, the method may include receiving, from a base station, control information identifying a configuration for transmission of an aperiodic sounding reference signal. The operations of 2005 may be performed in accordance with examples as disclosed herein. In some examples, aspects of the operations of 2005 may be performed by a configuration manager 1325 as described with reference to FIG. 13.

At 2010, the method may include receiving, from the base station, a downlink control message including a set of one or more blocks, where each block of the one or more blocks includes a sounding reference signal request in accordance with the configuration for transmission of an aperiodic sounding reference signal, an indication of an available slot corresponding to that block, and one or more transmit power control commands. The operations of 2010 may be performed in accordance with examples as disclosed herein. In some examples, aspects of the operations of 2010 may be performed by a control manager 1330 as described with reference to FIG. 13.

At 2015, the method may include transmitting, during the available slot corresponding to a block of the set of one or more blocks, the aperiodic sounding reference signal in accordance with a power level indicated by the one or more transmit power control commands corresponding to the block. The operations of 2015 may be performed in accordance with examples as disclosed herein. In some examples, aspects of the operations of 2015 may be performed by a reference manager 1335 as described with reference to FIG. 13.

At 2020, the method may include identifying, based on the configuration, a set of uplink component carriers that correspond to the block. The operations of 2020 may be performed in accordance with examples as disclosed herein. In some examples, aspects of the operations of 2020 may be performed by a configuration manager 1325 as described with reference to FIG. 13.

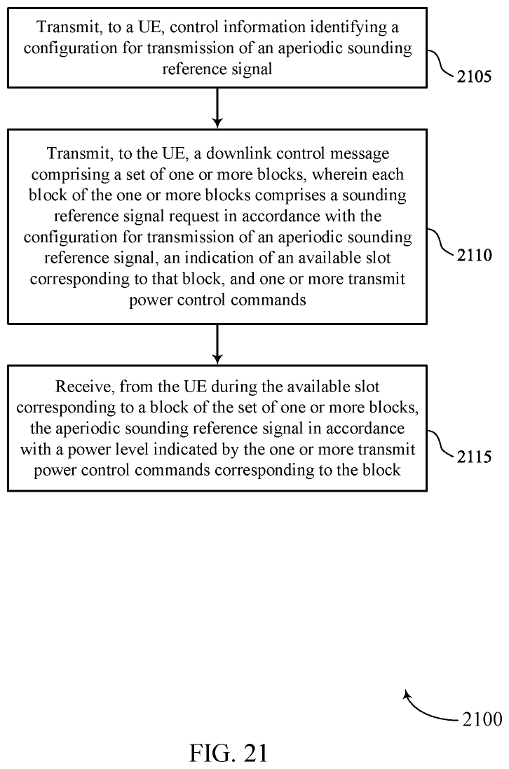

FIG. 21 shows a flowchart illustrating a method 2100 that supports reference signal available slot indication by group common downlink control information in accordance with aspects of the present disclosure. The operations of the method 2100 may be implemented by a base station or its components as described herein. For example, the operations of the method 2100 may be performed by a base station 105 as described with reference to FIGS. 1 through 10 and 15 through 18. In some examples, a base station may execute a set of instructions to control the functional elements of the base station to perform the described functions. Additionally or alternatively, the base station may perform aspects of the described functions using special-purpose hardware.

At 2105, the method may include transmitting, to a UE, control information identifying a configuration for transmission of an aperiodic sounding reference signal. The operations of 2105 may be performed in accordance with examples as disclosed herein. In some examples, aspects of the operations of 2105 may be performed by an aperiodic manager 1725 as described with reference to FIG. 17.

At 2110, the method may include transmitting, to the UE, a downlink control message including a set of one or more blocks, where each block of the one or more blocks includes a sounding reference signal request in accordance with the configuration for transmission of an aperiodic sounding reference signal, an indication of an available slot corresponding to that block, and one or more transmit power control commands. The operations of 2110 may be performed in accordance with examples as disclosed herein. In some examples, aspects of the operations of 2110 may be performed by a downlink manager 1730 as described with reference to FIG. 17.

At 2115, the method may include receiving, from the UE during the available slot corresponding to a block of the set of one or more blocks, the aperiodic sounding reference signal in accordance with a power level indicated by the one or more transmit power control commands corresponding to the block. The operations of 2115 may be performed in accordance with examples as disclosed herein. In some examples, aspects of the operations of 2115 may be performed by a sounding manager 1735 as described with reference to FIG. 17.

The following provides an overview of aspects of the present disclosure:

Aspect 1: A method for wireless communication at a UE, comprising: receiving, from a base station, control information identifying a configuration for transmission of an aperiodic sounding reference signal; receiving, from the base station, a downlink control message comprising a set of one or more blocks, wherein each block of the one or more blocks comprises a sounding reference signal request in accordance with the configuration for transmission of an aperiodic sounding reference signal, an indication of an available slot corresponding to that block, and one or more transmit power control commands; and transmitting, during the available slot corresponding to a block of the set of one or more blocks, the aperiodic sounding reference signal in accordance with a power level indicated by the one or more transmit power control commands corresponding to the block.

Aspect 2: The method of aspect 1, comprising: identifying, based at least in part on the configuration, a set of uplink component carriers that correspond to the block.

Aspect 3: The method of aspect 2, wherein transmitting the aperiodic sounding reference signal during the identified slot further comprises: transmitting the aperiodic sounding reference signal on each component carrier of the set of uplink component carriers corresponding to the block.

Aspect 4: The method of any of aspects 2 through 3, comprising: identifying, based at least in part on the configuration, a first component carrier of the set of uplink component carriers that corresponds to a first transmit power control command of the one or more transmit power control commands and a second component carrier of the set of uplink component carriers that corresponds to a second transmit power control command of the one or more transmit power control commands.

Aspect 5: The method of aspect 4, wherein transmitting the aperiodic sounding reference signal during the identified slot further comprises: transmitting the aperiodic sounding reference signal on the first component carrier at a first power level indicated by the first transmit power control command, and transmitting the aperiodic sounding reference signal on the second component carrier at a second power level indicated by the second transmit power control command, wherein the second power level is different than or equal to the first power level.

Aspect 6: The method of any of aspects 1 through 5, comprising: identifying, based at least in part on the configuration, a component carrier that corresponds to the block, wherein the component carrier corresponds to a transmit power control command of the one or more transmit power control commands; and transmitting the aperiodic sounding reference signal on the component carrier at a power level indicated by the transmit power control command.

Aspect 7: The method of any of aspects 1 through 6, comprising: identifying, based at least in part on the configuration, a mapping between the sounding reference signal request and the indication of an available slot, and that a set of sounding reference signal resources corresponds to the sounding reference signal request.

Aspect 8: The method of aspect 7, comprising: identifying, based at least in part on the configuration, a component carrier that corresponds to the set of sounding reference signal resources, wherein the component carrier corresponds to a transmit power control command of the one or more transmit power control commands; and using the set of sounding reference signal resources to transmit the aperiodic sounding reference signal on the component carrier at a power level indicated by the transmit power control command.

Aspect 9: The method of any of aspects 7 through 8, comprising: identifying, based at least in part on the configuration, a plurality of component carriers that correspond to the set of sounding reference signal resources, wherein the plurality of component carriers corresponds to a transmit power control command of the one or more transmit power control commands, wherein each of the plurality of component carriers point to the block; and using the set of sounding reference signal resources to transmit, during the identified slot, the aperiodic sounding reference signal on each of the plurality of component carriers at a power level indicated by the transmit power control command.

Aspect 10: The method of any of aspects 1 through 9, comprising: identifying the indication of the available slot based at least in part on the configuration, wherein the configuration maps the indication of the available slot to the block.

Aspect 11: The method of any of aspects 1 through 10, comprising: identifying a second indication of one or more available slots in an available slots field of a second block.

Aspect 12: The method of any of aspects 1 through 11, wherein the configuration or the downlink control message, or both, comprise a first pointer associated with a third block that points to a third indication of one or more available slots, and the configuration or the downlink control message, or both, comprise a second pointer associated with the third block that points to a sounding reference signal request and one or more transmit power control commands of the third block.

Aspect 13: The method of any of aspects 1 through 12, comprising: identifying a first component carrier of a set of uplink component carriers associated with the block that corresponds to the indication of the available slot and a second component carrier of the set of uplink component carriers that corresponds to a second indication of one or more available slots, wherein the available slots field of the block includes the second indication of the one or more available slots.

Aspect 14: The method of any of aspects 1 through 13, wherein the indication of the available slot comprises a slot offset value, and identifying the slot comprises identifying the slot based at least in part on the slot offset value.

Aspect 15: The method of aspect 14, wherein identifying the slot comprises: identifying the slot based at least in part on a reference slot indicated by the configuration or the downlink control message, or indicated by both, wherein the reference slot is measured from the downlink control message, or from a combination of the downlink control message and a slot offset value, or a first slot available after the UE performs a component carrier switching procedure, or any combination thereof.

Aspect 16: The method of any of aspects 1 through 15, comprising: receiving a list of index values in the configuration, or in a message from the base station, wherein the configuration comprises an index value that maps to an entry of the list of index values, wherein the entry of the list of index values indicates the available slot that corresponds to the block.

Aspect 17: An apparatus for wireless communication at a UE, comprising a processor; memory coupled with the processor; and instructions stored in the memory and executable by the processor to cause the apparatus to perform a method of any of aspects 1 through 16.

Aspect 18: An apparatus for wireless communication at a UE, comprising at least one means for performing a method of any of aspects 1 through 16.

Aspect 19: A non-transitory computer-readable medium storing code for wireless communication at a UE, the code comprising instructions executable by a processor to perform a method of any of aspects 1 through 16.

Aspect 20: A method for wireless communication at a base station, comprising: transmitting, to a UE, control information identifying a configuration for transmission of an aperiodic sounding reference signal; transmitting, to the UE, a downlink control message comprising a set of one or more blocks, wherein each block of the one or more blocks comprises a sounding reference signal request in accordance with the configuration for transmission of an aperiodic sounding reference signal, an indication of an available slot corresponding to that block, and one or more transmit power control commands; and receiving, from the UE during the available slot corresponding to a block of the set of one or more blocks, the aperiodic sounding reference signal in accordance with a power level indicated by the one or more transmit power control commands corresponding to the block.

Aspect 21: An apparatus for wireless communication at a base station, comprising a processor; memory coupled with the processor; and instructions stored in the memory and executable by the processor to cause the apparatus to perform the method of aspect 20.

Aspect 22: An apparatus for wireless communication at a base station, comprising at least one means for performing the method of aspect 20.

Aspect 23: A non-transitory computer-readable medium storing code for wireless communication at a base station, the code comprising instructions executable by a processor to perform the method of aspect 20.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
receive, from a base station, control information identifying a configuration for transmission of an aperiodic sounding reference signal;
receive, from the base station, a downlink control message comprising a set of one or more blocks, wherein each block of the one or more blocks comprises a sounding reference signal request in accordance with the configuration for transmission of an aperiodic sounding reference signal, an indication of an available slot corresponding to that block, and one or more transmit power control commands; and
transmit, during the available slot corresponding to a block of the set of one or more blocks, the aperiodic sounding reference signal in accordance with a power level indicated by the one or more transmit power control commands corresponding to the block.

2. The apparatus of claim 1, wherein the instructions are further executable by the processor to cause the apparatus to:
identify, based at least in part on the configuration, a set of uplink component carriers that correspond to the block.

3. The apparatus of claim 2, wherein the instructions to transmit the aperiodic sounding reference signal during the identified slot are further executable by the processor to cause the apparatus to:
transmit the aperiodic sounding reference signal on each component carrier of the set of uplink component carriers corresponding to the block.

4. The apparatus of claim 2, wherein the instructions are further executable by the processor to cause the apparatus to:
identify, based at least in part on the configuration, a first component carrier of the set of uplink component carriers that corresponds to a first transmit power control command of the one or more transmit power control commands and a second component carrier of the set of uplink component carriers that corresponds to a second transmit power control command of the one or more transmit power control commands.

5. The apparatus of claim 4, wherein the instructions to transmit the aperiodic sounding reference signal during the identified slot are further executable by the processor to cause the apparatus to:
transmit the aperiodic sounding reference signal on the first component carrier at a first power level indicated by the first transmit power control command, and transmitting the aperiodic sounding reference signal on the second component carrier at a second power level indicated by the second transmit power control command, wherein the second power level is different than or equal to the first power level.

6. The apparatus of claim 1, wherein the instructions are further executable by the processor to cause the apparatus to:
identify, based at least in part on the configuration, a component carrier that corresponds to the block, wherein the component carrier corresponds to a transmit power control command of the one or more transmit power control commands; and
transmit the aperiodic sounding reference signal on the component carrier at a power level indicated by the transmit power control command.

7. The apparatus of claim 1, wherein the instructions are further executable by the processor to cause the apparatus to:
identify, based at least in part on the configuration, a mapping between the sounding reference signal request and the indication of an available slot, and that a set of sounding reference signal resources corresponds to the sounding reference signal request.

8. The apparatus of claim 7, wherein the instructions are further executable by the processor to cause the apparatus to:
identify, based at least in part on the configuration, a component carrier that corresponds to the set of sounding reference signal resources, wherein the component carrier corresponds to a transmit power control command of the one or more transmit power control commands; and
used the set of sounding reference signal resources to transmit the aperiodic sounding reference signal on the component carrier at a power level indicated by the transmit power control command.

9. The apparatus of claim 7, wherein the instructions are further executable by the processor to cause the apparatus to:
identify, based at least in part on the configuration, a plurality of component carriers that correspond to the set of sounding reference signal resources, wherein the plurality of component carriers corresponds to a transmit power control command of the one or more transmit power control commands, wherein each of the plurality of component carriers point to the block; and
used the set of sounding reference signal resources to transmit, during the identified slot, the aperiodic sounding reference signal on each of the plurality of component carriers at a power level indicated by the transmit power control command.

10. The apparatus of claim 1, wherein the instructions are further executable by the processor to cause the apparatus to:
identify the indication of the available slot based at least in part on the configuration, wherein the configuration maps the indication of the available slot to the block.

11. The apparatus of claim 1, wherein the instructions are further executable by the processor to cause the apparatus to:
identify a second indication of one or more available slots in an available slots field of a second block.

12. The apparatus of claim 1, wherein:
the configuration or the downlink control message, or both, comprise a first pointer associated with a third block that points to a third indication of one or more available slots, and
the configuration or the downlink control message, or both, comprise a second pointer associated with the third block that points to a sounding reference signal request and one or more transmit power control commands of the third block.

13. The apparatus of claim 1, wherein the instructions are further executable by the processor to cause the apparatus to:
identify a first component carrier of a set of uplink component carriers associated with the block that corresponds to the indication of the available slot and a second component carrier of the set of uplink component carriers that corresponds to a second indication of one or more available slots, wherein the available slots field of the block includes the second indication of the one or more available slots.

14. The apparatus of claim 1, wherein:
the indication of the available slot comprises a slot offset value, and
identifying the slot comprises identifying the slot based at least in part on the slot offset value.

15. The apparatus of claim 14, wherein the instructions to identify the slot are executable by the processor to cause the apparatus to:
identify the slot based at least in part on a reference slot indicated by the configuration or the downlink control message, or indicated by both, wherein the reference slot is measured from the downlink control message, or from a combination of the downlink control message and a slot offset value, or a first slot available after the UE performs a component carrier switching procedure, or any combination thereof.

16. The apparatus of claim 1, wherein the instructions are further executable by the processor to cause the apparatus to:
receive a list of index values in the configuration, or in a message from the base station, wherein the configuration comprises an index value that maps to an entry of the list of index values, wherein the entry of the list of index values indicates the available slot that corresponds to the block.

17. A method for wireless communication at a user equipment (UE), comprising:
receiving, from a base station, control information identifying a configuration for transmission of an aperiodic sounding reference signal;
receiving, from the base station, a downlink control message comprising a set of one or more blocks, wherein each block of the one or more blocks comprises a sounding reference signal request in accordance with the configuration for transmission of an aperiodic sounding reference signal, an indication of an available slot corresponding to that block, and one or more transmit power control commands; and
transmitting, during the available slot corresponding to a block of the set of one or more blocks, the aperiodic sounding reference signal in accordance with a power level indicated by the one or more transmit power control commands corresponding to the block.

18. The method of claim 17, comprising:
identifying, based at least in part on the configuration, a set of uplink component carriers that correspond to the block.

19. The method of claim 18, wherein transmitting the aperiodic sounding reference signal during the identified slot further comprises:
transmitting the aperiodic sounding reference signal on each component carrier of the set of uplink component carriers corresponding to the block.

20. The method of claim 18, comprising:
identifying, based at least in part on the configuration, a first component carrier of the set of uplink component carriers that corresponds to a first transmit power control command of the one or more transmit power control commands and a second component carrier of the set of uplink component carriers that corresponds to a second transmit power control command of the one or more transmit power control commands.

21. The method of claim 20, wherein transmitting the aperiodic sounding reference signal during the identified slot further comprises:
transmitting the aperiodic sounding reference signal on the first component carrier at a first power level indicated by the first transmit power control command, and transmitting the aperiodic sounding reference signal on the second component carrier at a second power level indicated by the second transmit power control command, wherein the second power level is different than or equal to the first power level.

22. The method of claim 17, comprising:
identifying, based at least in part on the configuration, a component carrier that corresponds to the block, wherein the component carrier corresponds to a transmit power control command of the one or more transmit power control commands; and
transmitting the aperiodic sounding reference signal on the component carrier at a power level indicated by the transmit power control command.

23. The method of claim 17, comprising:
identifying, based at least in part on the configuration, a mapping between the sounding reference signal request and the indication of an available slot, and that a set of sounding reference signal resources corresponds to the sounding reference signal request.

24. The method of claim 23, comprising:
identifying, based at least in part on the configuration, a component carrier that corresponds to the set of sounding reference signal resources, wherein the component carrier corresponds to a transmit power control command of the one or more transmit power control commands; and
using the set of sounding reference signal resources to transmit the aperiodic sounding reference signal on the component carrier at a power level indicated by the transmit power control command.

25. The method of claim 23, comprising:
identifying, based at least in part on the configuration, a plurality of component carriers that correspond to the set of sounding reference signal resources, wherein the plurality of component carriers corresponds to a transmit power control command of the one or more transmit power control commands, wherein each of the plurality of component carriers point to the block; and
using the set of sounding reference signal resources to transmit, during the identified slot, the aperiodic sounding reference signal on each of the plurality of component carriers at a power level indicated by the transmit power control command.

26. The method of claim 17, comprising:
identifying the indication of the available slot based at least in part on the configuration, wherein the configuration maps the indication of the available slot to the block.

27. The method of claim 17, comprising:
identifying a second indication of one or more available slots in an available slots field of a second block.

28. The method of claim 17, wherein
the configuration or the downlink control message, or both, comprise a first pointer associated with a third block that points to a third indication of one or more available slots, and
the configuration or the downlink control message, or both, comprise a second pointer associated with the third block that points to a sounding reference signal request and one or more transmit power control commands of the third block.

29. An apparatus for wireless communication at a base station, comprising:
a processor;
memory coupled with the processor; and
instructions stored in the memory and executable by the processor to cause the apparatus to:
transmit, to a user equipment (UE), control information identifying a configuration for transmission of an aperiodic sounding reference signal;
transmit, to the UE, a downlink control message comprising a set of one or more blocks, wherein each block of the one or more blocks comprises a sounding reference signal request in accordance with the configuration for transmission of an aperiodic sounding reference signal, an indication of an available slot corresponding to that block, and one or more transmit power control commands; and
receive, from the UE during the available slot corresponding to a block of the set of one or more blocks, the aperiodic sounding reference signal in accordance with a power level indicated by the one or more transmit power control commands corresponding to the block.

30. A method for wireless communication at a base station, comprising:
transmitting, to a user equipment (UE), control information identifying a configuration for transmission of an aperiodic sounding reference signal;
transmitting, to the UE, a downlink control message comprising a set of one or more blocks, wherein each block of the one or more blocks comprises a sounding reference signal request in accordance with the configuration for transmission of an aperiodic sounding reference signal, an indication of an available slot corresponding to that block, and one or more transmit power control commands; and
receiving, from the UE during the available slot corresponding to a block of the set of one or more blocks, the aperiodic sounding reference signal in accordance with a power level indicated by the one or more transmit power control commands corresponding to the block.
